(19) United States
(12) Patent Application Publication
(10) Pub. No.: US 2025/0149767 A1
(43) Pub. Date: May 8, 2025

(54) PHASE SHIFTER AND ANTENNA

(71) Applicant: Shanghai Tianma Microelectronics Co., Ltd., Shanghai (CN)

(72) Inventors: Yifan BAO, Shanghai (CN); Baiquan LIN, Shanghai (CN); Yifan XING, Shanghai (CN); Xiaonan HAN, Shanghai (CN); Taohua CHEN, Shanghai (CN)

(73) Assignee: Shanghai Tianma Microelectronics Co., Ltd., Shanghai (CN)

(21) Appl. No.: 19/014,632

(22) Filed: Jan. 9, 2025

(30) Foreign Application Priority Data
Sep. 25, 2024 (CN) 202411353634.5

(51) Int. Cl. H01P 1/18; H01Q 3/36

(52) U.S. Cl. CPC H01P 1/184; H01Q 3/36

(57) ABSTRACT

A phase shifter includes a first substrate and a second substrate that are arranged opposite to each other and at least one phase shift unit, where the phase shift unit includes a microstrip line, an auxiliary electrode, a liquid crystal layer, and a grounding metal layer, and the auxiliary electrode is located between the first substrate and the liquid crystal layer and/or the auxiliary electrode is located between the second substrate and the liquid crystal layer.

### CROSS-REFERENCE TO RELATED APPLICATION(S)

This application claims priority to Chinese Patent Application No. 202411353634.5 filed Sep. 25, 2024, the disclosure of which is incorporated herein by reference in its entirety.

### TECHNICAL FIELD

The present disclosure relates to the field of communications and, in particular, to a phase shifter and an antenna.

### BACKGROUND

A liquid crystal antenna, based on the anisotropic characteristic of a liquid crystal molecule, controls the orientation of the liquid crystal molecule by using an electrical signal and then changes the dielectric parameters of phase shift units to control the phase of a radio frequency signal in each phase shift unit, thereby ultimately achieving the control of pointing of a radiation beam of the antenna. The liquid crystal antenna can be widely used in satellite communications, a 5G millimeter wave base station, and other scenarios.

However, the existing liquid crystal antenna has the problem of a long response duration of deflection of liquid crystal molecule under some working conditions, thereby leading to the liquid crystal antenna failing to complete the beam pointing change quickly and affecting the tracking performance of the antenna.

### SUMMARY

The present disclosure provides a phase shifter and an antenna.

According to an aspect of the present disclosure, a phase shifter is provided. The phase shifter includes a first substrate, a second substrate, and at least one phase shift unit.

The first substrate and the second substrate are disposed opposite to each other.

The phase shift unit includes a microstrip line, an auxiliary electrode, a liquid crystal layer, and a grounding metal layer.

The liquid crystal layer is located between the first substrate and the second substrate.

The microstrip line is located on a side of the second substrate facing the liquid crystal layer.

The grounding metal layer is located on a side of the first substrate facing the liquid crystal layer.

The auxiliary electrode is located between the first substrate and the liquid crystal layer and/or the auxiliary electrode is located between the second substrate and the liquid crystal layer.

According to another aspect of the present disclosure, an antenna is provided. The antenna includes the phase shifter described in the first aspect.

It is to be understood that the content described in this section is neither intended to identify key or critical features of the embodiments of the present disclosure nor intended to limit the scope of the present disclosure. Other features of the present disclosure become easily understood through the description provided hereinafter.

### BRIEF DESCRIPTION OF DRAWINGS

To illustrate solutions in the embodiments of the present disclosure more clearly, the drawings used in the description of the embodiments are briefly described below.

FIG. 1 is a structure view of a phase shifter according to one or more embodiments of the present disclosure;

FIG. 2 is an enlarged view of part A in FIG. 1;

FIG. 3 is a sectional view taken along B-B′ in FIG. 2;

FIG. 4 is a partial sectional view of a phase shifter according to one or more embodiments of the present disclosure;

FIGS. 5 to 7 are partial sectional views of a phase shifter in the related art;

FIGS. 8 and 9 are partial sectional views of another phase shifter according to one or more embodiments of the present disclosure;

FIG. 10 is a partial sectional view of another phase shifter according to one or more embodiments of the present disclosure;

FIG. 11 is a partial sectional view of another phase shifter according to one or more embodiments of the present disclosure;

FIG. 12 is a working timing view of a phase shifter according to one or more embodiments of the present disclosure;

FIG. 13 is a partial sectional view of a phase shifter in a first state stage according to one or more embodiments of the present disclosure;

FIG. 14 is a partial sectional view of a phase shifter in a second state stage according to one or more embodiments of the present disclosure;

FIG. 15 is a partial structure view of a phase shifter according to one or more embodiments of the present disclosure;

FIG. 16 is a sectional view taken along C-C′ in FIG. 15;

FIG. 17 is a partial structure view of another phase shifter according to one or more embodiments of the present disclosure;

FIG. 18 is a sectional view taken along D-D′ in FIG. 17;

FIG. 19 is a partial structure view of another phase shifter according to one or more embodiments of the present disclosure;

FIG. 20 is a sectional view taken along E-E′ in FIG. 19;

FIG. 21 is a partial sectional view of another phase shifter according to one or more embodiments of the present disclosure;

FIG. 22 is a partial sectional view of another phase shifter according to one or more embodiments of the present disclosure;

FIG. 23 is a partial sectional view of another phase shifter according to one or more embodiments of the present disclosure;

FIG. 24 is a partial sectional view of another phase shifter according to one or more embodiments of the present disclosure;

FIG. 25 is a partial structure view of another phase shifter according to one or more embodiments of the present disclosure;

FIG. 26 is a structure view of a phase shift unit according to one or more embodiments of the present disclosure;

FIG. 27 is a partial structure view of another phase shifter according to one or more embodiments of the present disclosure;

FIG. 28 is a structure view of an antenna according to one or more embodiments of the present disclosure; and

FIG. 29 is a partial sectional view of an antenna according to one or more embodiments of the present disclosure.

### DETAILED DESCRIPTION

To make the solutions of the present disclosure better understood by those skilled in the art, the solutions in the embodiments of the present disclosure are described below clearly and completely in conjunction with drawings in the embodiments of the present disclosure. Apparently, the embodiments described below are part, not all, of the embodiments of the present disclosure. Based on the embodiments of the present disclosure, all other embodiments obtained by those of ordinary skill in the art on the premise that no creative work is done are within the scope of the present disclosure.

It is to be noted that terms such as “first” and “second” in the description, claims, and drawings of the present disclosure are used for distinguishing between similar objects and are not necessarily used for describing a particular order or sequence. It is to be understood that the data used in this manner is interchangeable in appropriate cases so that the embodiments of the present disclosure described herein can be implemented in an order not illustrated or described herein. In addition, the terms “including”, “having”, and any other variations thereof are intended to cover a non-exclusive inclusion. For example, a process, a method, a system, a product, or a device that includes a series of steps or units may include not only the expressly listed steps or units but also other steps or units that are not expressly listed or are inherent to the process, the method, the product, or the device.

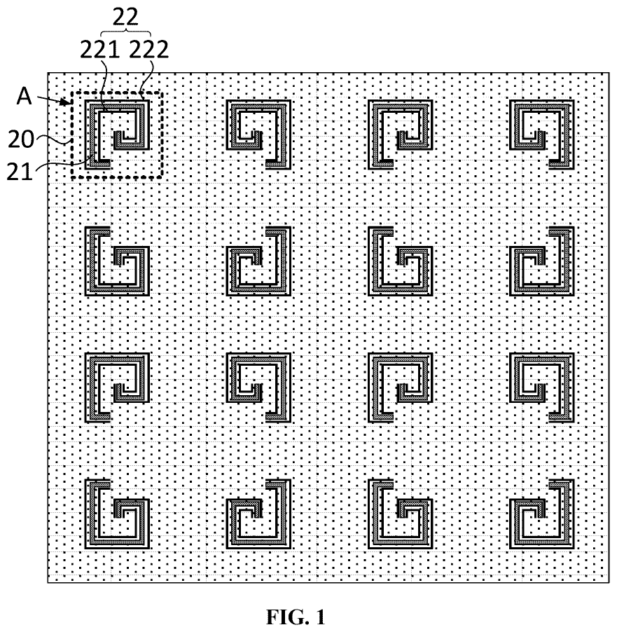

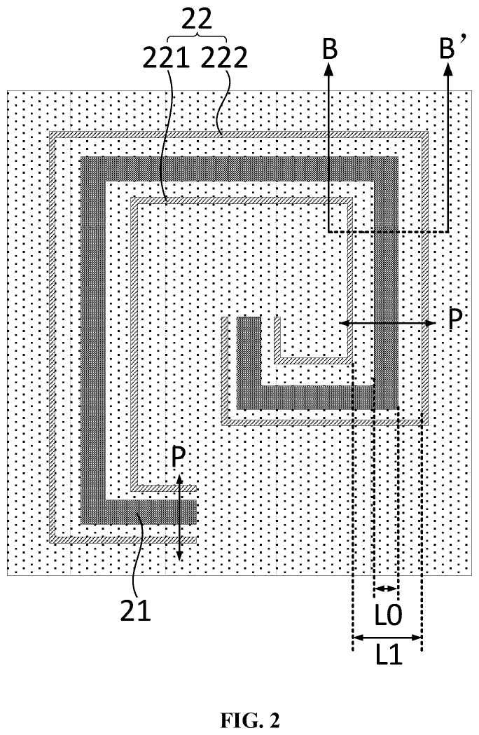

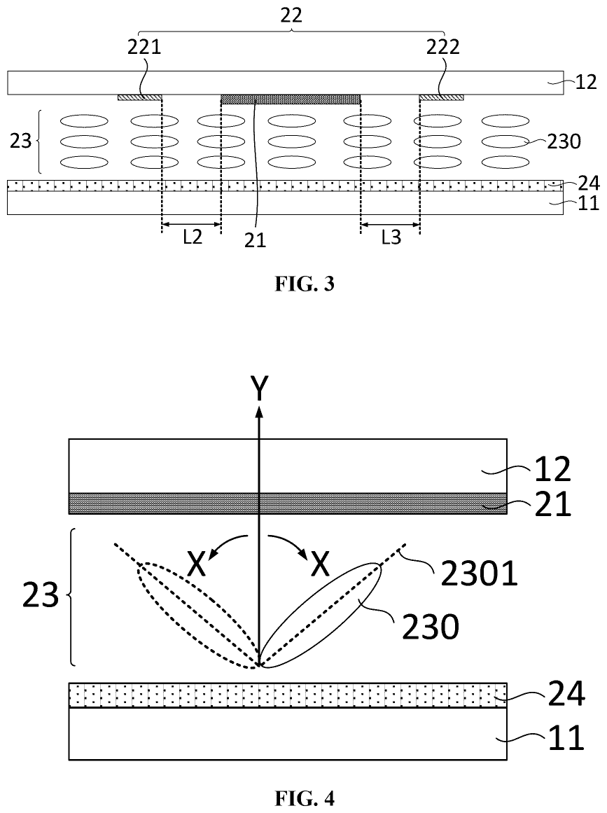

FIG. 1 is a structure view of a phase shifter according to one or more embodiments of the present disclosure, FIG. 2 is an enlarged view of part A in FIG. 1, FIG. 3 is a sectional view taken along B-B′ in FIG. 2, and FIG. 4 is a partial sectional view of a phase shifter according to one or more embodiments of the present disclosure. As shown in FIGS. 1 to 4, the phase shifter provided by the embodiments of the present disclosure includes a first substrate 11, a second substrate 12, and at least one phase shift unit 20 to increase the response speed of beam steering.

The first substrate 11 and the second substrate 12 are disposed opposite to each other.

The phase shift unit 20 includes a microstrip line 21, an auxiliary electrode 22, a liquid crystal layer 23, and a grounding metal layer 24.

The liquid crystal layer 23 is located between the first substrate 11 and the second substrate 12.

The microstrip line 21 is located on a side of the second substrate 12 facing the liquid crystal layer 23.

The grounding metal layer 24 is located on a side of the first substrate 11 facing the liquid crystal layer 23.

The auxiliary electrode 22 is located between the first substrate 11 and the liquid crystal layer 23 and/or the auxiliary electrode 22 is located between the second substrate 12 and the liquid crystal layer 23.

In the phase shifter and the antenna provided by the embodiments of the present disclosure, an auxiliary electrode is disposed between the first substrate and the liquid crystal layer and/or between the second substrate and the liquid crystal layer, the auxiliary electrode is used for forming a transverse electric field in the liquid crystal layer, and a liquid crystal molecule in the liquid crystal layer is driven to be deflected in a first direction by an electric field force to increase the speed of the deflection of the liquid crystal molecule in the first direction, reduced the response duration of the deflection of the liquid crystal molecule in the first direction, and increase the speed of beam steering, thereby improving the tracking performance of the antenna.

Specifically, as shown in FIGS. 1 to 3, the phase shifter provided by the embodiments of the present disclosure is a liquid crystal phase shifter (LCPS) which refers to a component or a device capable of adjusting the phase of a beam.

The phase shifter includes a first substrate 11 and a second substrate 12 that are disposed opposite to each other and at least one phase shift unit 20. The phase shift unit 20 includes a liquid crystal layer 23 disposed between the first substrate 11 and the second substrate 12. A microstrip line 21 is disposed on a side of the liquid crystal layer 23 facing away from the first substrate 11. A grounding metal layer 24 is disposed on a side of the liquid crystal layer 23 facing away from the second substrate 12. In the embodiments, the microstrip line 21 is connected to a drive voltage to form an electric field between the microstrip line 21 and the grounding metal layer 24, and the electric field is capable of driving a liquid crystal molecule 230 in the liquid crystal layer 23 to be deflected, thereby changing the dielectric constant of the liquid crystal layer 23.

Optionally, the microstrip line 21 is also used for transmitting a radio frequency signal. The radio frequency signal is transmitted in the liquid crystal layer 23 between the microstrip line 21 and the grounding metal layer 24. Due to the change in the dielectric constant of the liquid crystal layer 23, the radio frequency signal transmitted on the microstrip line 21 is phase-shifted, and the phase of the radio frequency signal is changed, thereby achieving a phase shift function of the radio frequency signal.

It is to be noted that the phase shifter may include one phase shift unit 20, the one phase shift unit 20 includes one microstrip line 21, and the phase shift unit 20 is used for achieving the phase shift function of the radio frequency signal transmitted on the microstrip line 21. Optionally, the phase shifter may also include multiple phase shift units 20 disposed in an array to simultaneously perform phase shifting on radio frequency signals transmitted on multiple microstrip lines 21. In FIG. 1, the phase shifter including 16 phase shift units is illustrated. In other embodiments, those skilled in the art can set the number and layout of the phase shift units 20 according to actual requirements, and the embodiments of the present disclosure do not make any limitations in this regard.

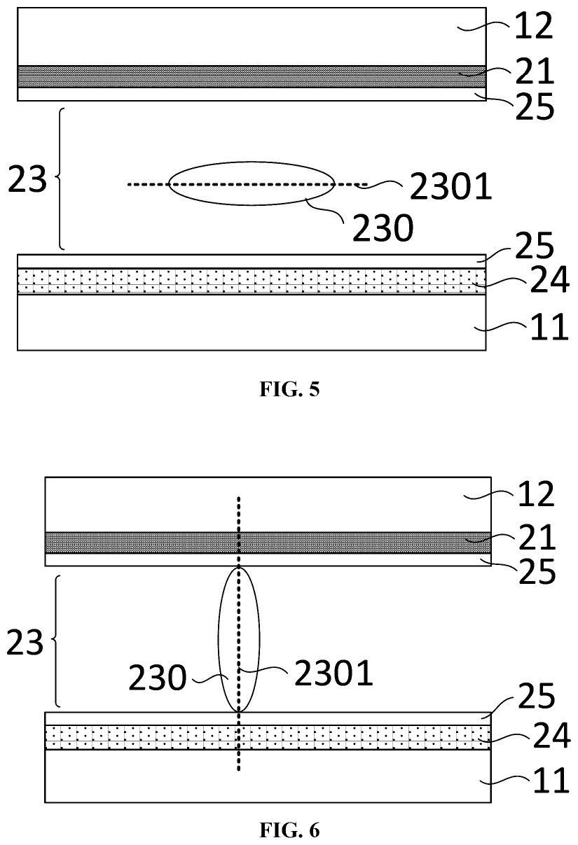

FIGS. 5 to 7 are partial sectional views of a phase shifter in the related art. As shown in FIGS. 5 to 7, optionally, an alignment layer 25 is disposed on a side of the microstrip line 21 facing the liquid crystal layer 23 and/or on a side of the grounding metal layer 24 facing the liquid crystal layer 23. The alignment layer 25 is used for providing a pretilt angle for each liquid crystal molecule 230 in the liquid crystal layer 23 to perform alignment on the liquid crystal layer 23.

The alignment layer 25 may be formed of a polymer material such as polyimide (PI), which is not limited thereto.

Further, the liquid crystal layer 23 may adopt a twisted nematic (TN) mode or another alignment mode, and the embodiments of the present disclosure do not make any specific limitations in this regard.

The inventors have discovered that, as shown in FIG. 5, when no drive voltage is applied to the microstrip line 21, the liquid crystal molecule 230 is in a falling-over state. In this case, the alignment of the liquid crystal molecule 230 is affected by the alignment layer 25, and the extension direction of the long axis 2301 of the liquid crystal molecule 230 is parallel to a plane on which the first substrate 11 is located.

As shown in FIG. 6, when a drive voltage is applied to the microstrip line 21 to form a strong electric field between the microstrip line 21 and the grounding metal layer 24, the strong electric field drives the liquid crystal molecule 230 to be deflected so that the liquid crystal molecule 230 changes from the falling-over state to an upright state. In this case, the orientation of the liquid crystal molecule 230 is mainly affected by the electric field, and the extension direction of the long axis 2301 of the liquid crystal molecule 230 is perpendicular to the plane on which the first substrate 11 is located. In this manner, the dielectric constant of the liquid crystal layer 23 may be changed, the radio frequency signal transmitted on the microstrip line 21 is phase-shifted, and the phase of the radio frequency signal is changed, thereby achieving the phase shift function.

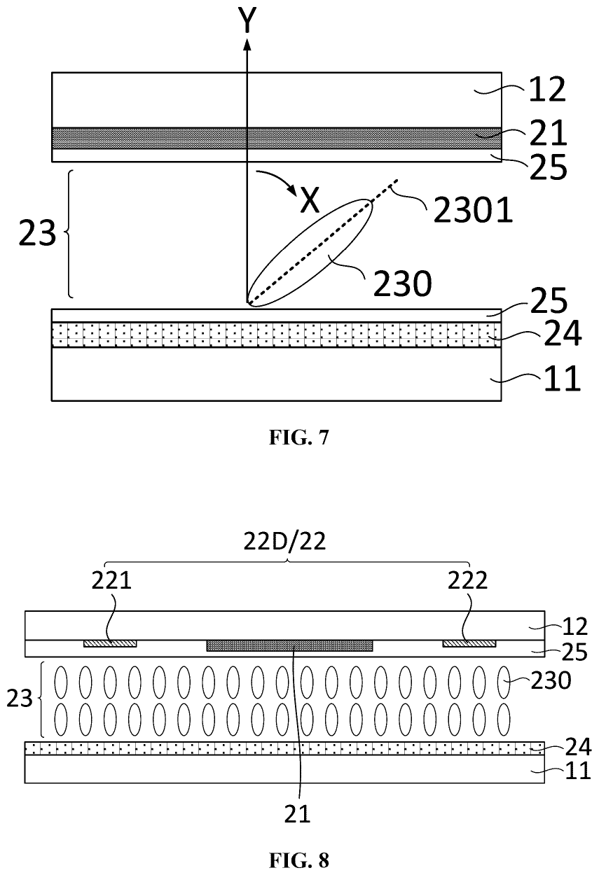

As shown in FIG. 7, when the drive voltage on the microstrip line 21 is stopped from being applied to make the electric field between the microstrip line 21 and the grounding metal layer 24 disappear or when the magnitude of the drive voltage applied to the microstrip line 21 is changed to make the strong electric field between the microstrip line 21 and the grounding metal layer 24 to change into a weak electric field, the liquid crystal molecule 230 changes from the upright state to the falling-over state. In this case, the liquid crystal molecule 230 needs to be deflected in a first direction X (that is a direction in which the long axis 2301 of the liquid crystal molecule 230 is deflected away from a direction (for example, a Y direction in the figure) perpendicular to the plane on which the first substrate 11 is located) to enable the liquid crystal molecule 230 to reach a predetermined deflection angle, thereby adjusting the dielectric constant of the liquid crystal layer 23, dynamically changing the phase of the radio frequency signal, and achieving the beam pointing change.

The force that drives the liquid crystal molecule 230 to be deflected in the first direction X is mainly a surface anchoring force of the alignment layer 25, and the surface anchoring force of the alignment layer 25 is weaker than the electric field force that drives the liquid crystal molecule 230 to change to the upright state. In this manner, when the liquid crystal molecule 230 changes from the falling-over state to the upright state, the liquid crystal molecule 230 may have a faster deflection speed. When the liquid crystal molecule 230 changes from the upright state to the falling-over state or when the liquid crystal molecule 230 needs to be deflected in the first direction X, the deflection speed of the liquid crystal molecule 230 is often slow, so the liquid crystal molecule 230 needs a long response duration to be deflected in the first direction X and the predetermined deflection angle cannot be quickly reached, thereby failing to complete the beam pointing change quickly and affecting the tracking performance of the antenna. For example, when a beam of the antenna needs to be pointed to a moving target, the adjustment of the beam pointing lags behind the actual location change of the moving target because the response duration of the liquid crystal molecule 230 to be deflected is relatively long, thereby resulting in the antenna failing to capture the moving target in time and affecting the performance of tracking the moving target.

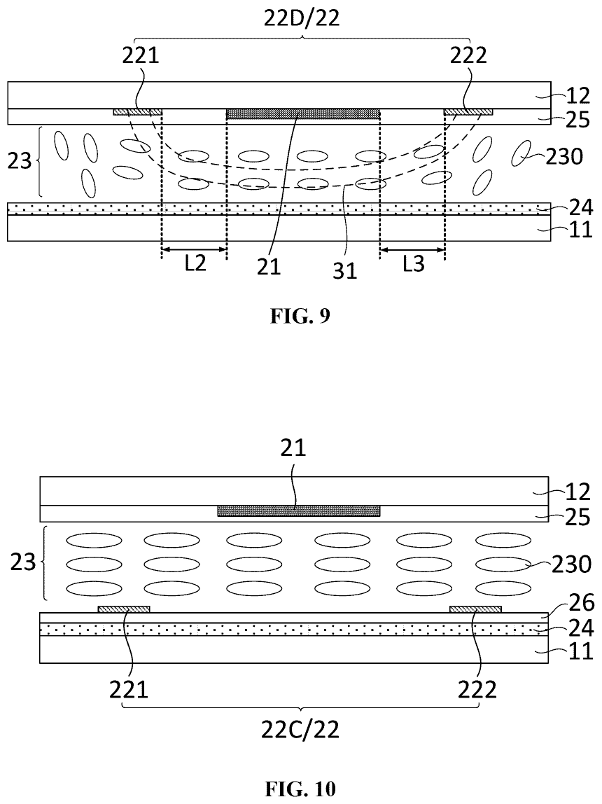

Based on the above problems, FIGS. 8 and 9 are partial sectional views of another phase shifter according to one or more embodiments of the present disclosure. As shown in FIGS. 1 to 4, 8, and 9, in the embodiments, the auxiliary electrode 22 is disposed between the first substrate 11 and the liquid crystal layer 23 and/or between the second substrate 12 and the liquid crystal layer 23. As shown in FIG. 9, the auxiliary electrode 22 may be used for forming a transverse electric field 31 in the liquid crystal layer 23, and the liquid crystal molecule 230 is deflected in a direction of the electric field, thereby achieving the deflection of the liquid crystal molecule 230 in the liquid crystal layer 23 under the driving of the electric field force. For example, the liquid crystal molecule 230 in the liquid crystal layer 23 is driven to be deflected in the first direction X by the electric field force. As shown in FIG. 4, the first direction X is a direction in which the long axis 2301 of the liquid crystal molecule 230 is deflected away from a direction (for example, the Y direction in the figure) perpendicular to the plane on which the first substrate 11 is located.

Through the above setting, when the liquid crystal molecule 230 needs to be deflected in the first direction X, the electric field force generated by the auxiliary electrode 22 may drive the liquid crystal molecule 230 to be deflected in the first direction X. Since the electric field force generated by the auxiliary electrode 22 is stronger than the surface anchoring force of the alignment layer 25, the liquid crystal molecule 230 may be deflected in the first direction X more quickly in response to the electric field to increase the speed at which the liquid crystal molecule 230 is deflected in the first direction X, reduce the response duration for the liquid crystal molecule 230 to be deflected in the first direction X, and increase the speed of beam steering, thereby improving the tracking performance of the antenna.

It is to be noted that, as shown in FIGS. 8 and 9, in the embodiments, the alignment layer 25 may be disposed on a side of the microstrip line 21 facing the liquid crystal layer 23, and the alignment layer 25 is used for providing a pretilt angle for each liquid crystal molecule 230 in the liquid crystal layer 23 to perform alignment on the liquid crystal layer 23.

Therefore, when the liquid crystal molecule 230 needs to be deflected in the first direction X, both the surface anchoring force of the alignment layer 25 and the electric field force generated by the auxiliary electrode 22 may drive the liquid crystal molecule 230 to be deflected in the first direction X to further increase the speed at which the liquid crystal molecule 230 is deflected in the first direction X, reduce the response duration for the liquid crystal molecule 230 to be deflected in the first direction X, and increase the speed of beam steering, thereby improving the tracking performance of the antenna.

Further, as shown in FIGS. 8 and 9, the vertical projection of the alignment layer 25 on the first substrate 11 may cover the vertical projection of the liquid crystal layer 23 on the first substrate 11 to perform alignment on the whole liquid crystal layer 23 so that the initial orientations of all the liquid crystal molecules 230 in the liquid crystal layer 23 are relatively consistent in the absence of the electric field. Since the initial orientations of the liquid crystal molecules 230 may affect the deflection angles of the liquid crystal molecules 230 after the electric field is applied, the deflection angles of the liquid crystal molecules 230 become more consistent when the liquid crystal molecules 230 have relatively consistent initial orientations, so the phase change of the radio frequency signal passing through the liquid crystal layer 23 is more uniform, thereby improving the precision of the beam pointing.

It is to be noted that in the drawings of some embodiments of the present disclosure, the alignment layer 25 disposed on a side of the grounding metal layer 24 facing the liquid crystal layer 23 is not explicitly shown, which does not constitute a limitation on the scope of the present disclosure. In practical application, the alignment layer 25 may be disposed on a side of the microstrip line 21 facing the liquid crystal layer 23 and/or on a side of the grounding metal layer 24 facing the liquid crystal layer 23 according to actual requirements, and the embodiments of the present disclosure do not make any specific limitations in this regard.

With continued reference to FIGS. 3, 8, and 9, optionally, the auxiliary electrode 22 may be disposed only between the second substrate 12 and the liquid crystal layer 23.

FIG. 10 is a partial sectional view of another phase shifter according to one or more embodiments of the present disclosure. As shown in FIG. 10, optionally, the auxiliary electrode 22 may also be disposed only between the first substrate 11 and the liquid crystal layer 23.

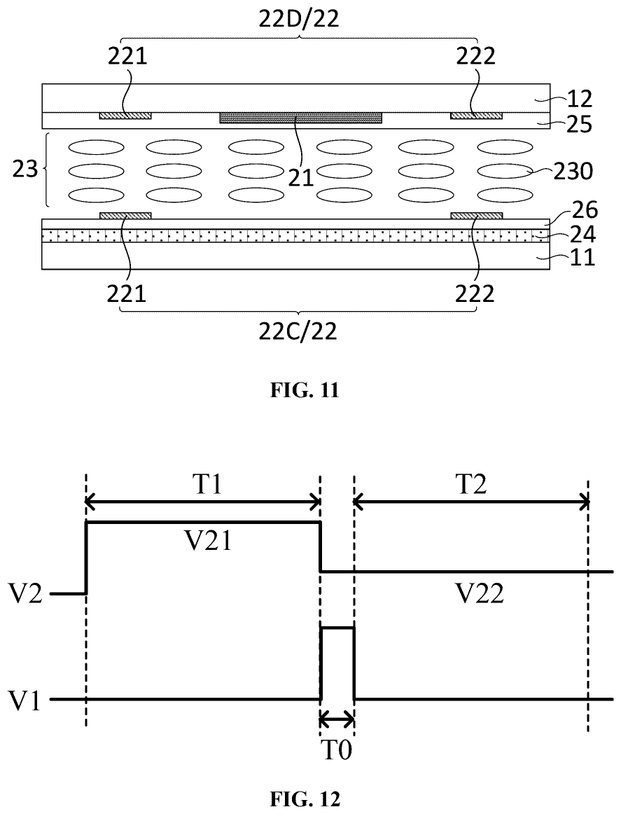

FIG. 11 is a partial sectional view of another phase shifter according to one or more embodiments of the present disclosure. As shown in FIG. 11, optionally, the auxiliary electrodes 22 may be both disposed between the second substrate 12 and the liquid crystal layer 23 and between the first substrate 11 and the liquid crystal layer 23, and the embodiments of the present disclosure do not make any specific limitations in this regard.

In summary, in the phase shifter provided by the embodiments of the present disclosure, the auxiliary electrode is disposed between the first substrate and the liquid crystal layer and/or between the second substrate and the liquid crystal layer, the auxiliary electrode is used for forming a transverse electric field in the liquid crystal layer, and the liquid crystal molecule in the liquid crystal layer is driven to be deflected in the first direction by the electric field force to increase the speed of the deflection of the liquid crystal molecule in the first direction, reduce the response duration for the deflection of the liquid crystal molecule in the first direction, and increase the speed of beam steering, thereby improving the tracking performance of the antenna.

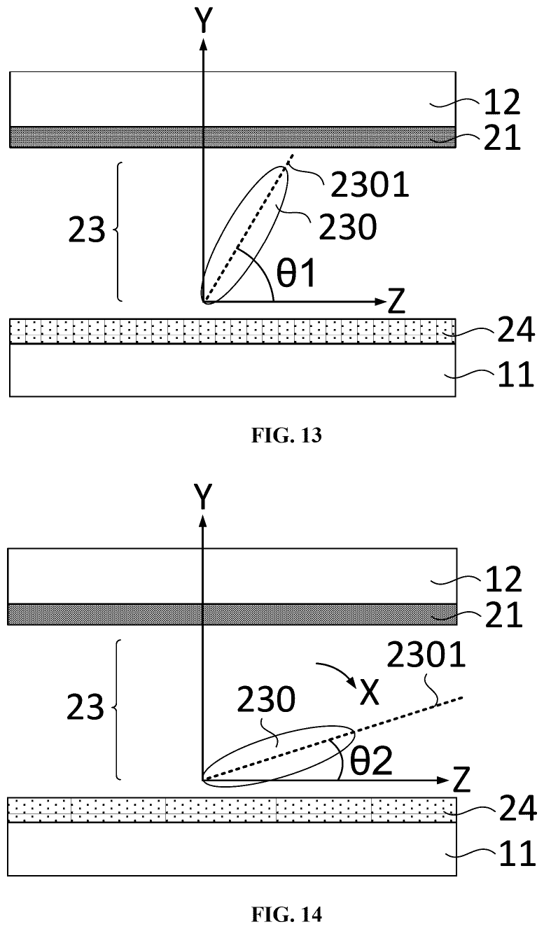

FIG. 12 is a working timing view of a phase shifter according to one or more embodiments of the present disclosure, FIG. 13 is a partial sectional view of a phase shifter in a first state stage according to one or more embodiments of the present disclosure, and FIG. 14 is a partial sectional view of a phase shifter in a second state stage according to one or more embodiments of the present disclosure. As shown in FIGS. 12 to 4, optionally, the working stage of the phase shifter sequentially includes a first state stage T1, a state switching stage T0, and a second state stage T2.

In the first state stage T1, the included angle between the long axis 2301 of the liquid crystal molecule 230 and a second direction Z is a first included angle θ1.

In the second state stage T2, the included angle between the long axis 2301 of the liquid crystal molecule 230 and the second direction Z is a second included angle θ2.

The first included angle θ1 is larger than the second included angle θ2, and the second direction Z is parallel to the plane on which the first substrate 11 is located.

In the state switching stage T0, the auxiliary electrode 22 is configured to drive the liquid crystal molecule 230 to be deflected in the first direction X, where the first direction X is a direction in which the long axis 2301 of the liquid crystal molecule 230 is deflected away from a direction (for example, the Y direction in the figure) perpendicular to the plane on which the first substrate 11 is located.

Specifically, as shown in FIG. 13, when the phase shifter is in the first state stage T1, the first included angle θ1 between the long axis 2301 of the liquid crystal molecule 230 and the second direction Z is relatively large, and in this case, the liquid crystal molecule 230 is approximately in the upright state.

As shown in FIG. 14, when the phase shifter is in the second state stage T2, the second included angle θ2 between the long axis 2301 of the liquid crystal molecule 230 and the second direction Z is relatively small, and in this case, the liquid crystal molecule 230 is approximately in the falling-over state.

When the phase shifter is switched from the first state stage T1 to the second state stage T2, the liquid crystal molecule 230 needs to be deflected in the first direction X. As described above, in the related art, the force that drives the liquid crystal molecule 230 to be deflected in the first direction X is the surface anchoring force of the alignment layer 25, and the surface anchoring force of the alignment layer 25 is relatively weak. Therefore, when the liquid crystal molecule 230 is deflected in the first direction X, the deflection speed of the liquid crystal molecule 230 is relatively slow, and the liquid crystal molecule 230 needs a relatively long response duration, thereby failing to complete the beam pointing change quickly and affecting the tracking performance of the antenna.

As shown in FIGS. 9 and 12, in the embodiments, the state switching stage T0 is set between the first state stage T1 and the second state stage T2. The state switching stage T0 is a transition stage in which the phase shifter is switched from the first state stage T1 to the second state stage T2 and is also a transition stage in which the included angle between the long axis 2301 of the liquid crystal molecule 230 and the second direction Z is deflected from the first included angle θ1 to the second included angle θ2.

In the state switching stage T0, the transverse electric field 31 may be formed in the liquid crystal layer 23 by the auxiliary electrode 22, and the electric field force generated by the auxiliary electrode 22 helps drive the liquid crystal molecule 230 in the liquid crystal layer 23 to be deflected in the first direction X. In this manner, the speed of the deflection of the liquid crystal molecule 230 in the first direction X is increased, and the duration of the deflection of the included angle between the long axis 2301 of the liquid crystal molecule 230 and the second direction Z transformed from the first included angle θ1 to the second included angle θ2 is reduced, that is, the response duration for the phase shifter to be switched from the first state stage T1 to the second state stage T2 is reduced, thereby increasing the speed of beam steering and improving the tracking performance of the antenna.

It is to be noted that the first direction X may refer to the deflection direction of the liquid crystal molecule 230 when the included angle between the long axis 2301 of the liquid crystal molecule 230 and the second direction Z is deflected from the first included angle θ1 to the second included angle θ2. In other words, the first direction X is the direction in which the liquid crystal molecule 230 is deflected from a state in which the long axis 2301 of the liquid crystal molecule 230 has a relatively large included angle with the plane on which the first substrate 11 is located to a state in which the long axis 2301 of the liquid crystal molecule 230 is closer to the plane on which the first substrate 11 is located.

In addition, the specific values of the first included angle θ1 and the second included angle θ2 may be set according to the practical working process, the first included angle θ1 may be set to be larger than the second included angle θ2, and the embodiments of the present disclosure do not make any specific limitations in this regard.

With continued reference to FIGS. 12 to 14, optionally, in the first state stage T1, the microstrip line 21 is configured to receive a first drive voltage V21.

In the state switching stage T0, the microstrip line 21 is configured to receive a second drive voltage V22, and the auxiliary electrode 22 is configured to receive an auxiliary voltage V1 to enable the auxiliary electrode 22 to drive the liquid crystal molecule 230 to be deflected in the first direction X.

In the second state stage T2, the microstrip line 21 is configured to receive the second drive voltage V22.

The voltage difference between the first drive voltage V21 and a voltage on the grounding metal layer 24 is a first voltage difference, the voltage difference between the second drive voltage V22 and the voltage on the grounding metal layer 24 is a second voltage difference, and the first voltage difference is larger than the second voltage difference.

Specifically, as described above, during the process of driving the phase shifter, the microstrip line 21 receives a drive voltage V2 to form an electric field between the microstrip line 21 and the grounding metal layer 24, and the electric field is used for controlling the liquid crystal molecule 230 in the liquid crystal layer 23 to be deflected to the predetermined deflection angle, thereby adjusting the dielectric constant of the liquid crystal layer 23. The radio frequency signal on the microstrip line 21 is transmitted in the liquid crystal layer 23 between the microstrip line 21 and the grounding metal layer 24, and the change in the dielectric constant of the liquid crystal layer 23 affects the phase of the radio frequency signal passing through the liquid crystal layer 23.

Therefore, the difference between the first included angle θ1 and the second included angle θ2 formed between the long axis 2301 of the liquid crystal molecule 230 and the second direction Z leads to the difference of the dielectric constants of the liquid crystal layer 23 of the phase shifter in the first state stage T1 and the second state stage T2 respectively, thereby achieving the phase change of the radio frequency signal and changing the beam pointing.

In the embodiments, as shown in FIG. 13, when the phase shifter is in the first state stage T1, the drive voltage V2 applied to the microstrip line 21 is the first drive voltage V21, and the first voltage difference formed between the first drive voltage V21 and the voltage on the grounding metal layer 24 is relatively large so that the first included angle θ1 that is relatively large is maintained between the long axis 2301 of the liquid crystal molecule 230 and the second direction Z. In this case, the liquid crystal molecule 230 is approximately in the upright state.

As shown in FIG. 14, when the phase shifter is in the second state stage T2, the drive voltage V2 applied to the microstrip line 21 is the second drive voltage V22, and the second voltage difference formed between the second drive voltage V22 and the voltage on the grounding metal layer 24 is relatively small so that the second included angle θ2 that is relatively small is maintained between the long axis 2301 of the liquid crystal molecule 230 and the second direction Z. In this case, the liquid crystal molecule 230 is approximately in the falling-over state.

In the state switching stage T0 between the first state stage T1 and the second state stage T2, the drive voltage V2 applied to the microstrip line 21 is the second drive voltage V22 to control the phase shifter to be switched from the first state stage T1 to the second state stage T2. In this case, the included angle between the long axis 2301 of the liquid crystal molecule 230 and the second direction Z is deflected from the first included angle θ1 to the second included angle θ2. Moreover, an auxiliary voltage V1 is applied to the auxiliary electrode 22 so that the auxiliary electrode 22 forms the transverse electric field in the liquid crystal layer 23. In this manner, the speed at which the liquid crystal molecule 230 in the liquid crystal layer 23 is deflected in the first direction X is increased by the electric field force generated by the auxiliary electrode 22, and the response duration for the phase shifter to be switched from the first state stage T1 to the second state stage T2 is reduced, thereby increasing the speed of beam steering and improving the tracking performance of the antenna.

It is to be noted that the voltage on the grounding metal layer 24 may be constant when the phase shifter is in both the first state stage T1 and the second state stage T2. For example, the grounding metal layer 24 may be connected to a fixed potential to reduce the complexity of applying the signal and improve stability and reliability, which is not limited thereto.

As shown in FIG. 12, in both the first state stage T1 and the second state stage T2, the phase shifter stops applying the auxiliary voltage V1 to the auxiliary electrode 22 to prevent the transversal electric field generated by the auxiliary electrode 22 from adversely affecting the electric field formed between the microstrip line 21 and the grounding metal layer 24 and ensure that the liquid crystal molecule 230 is maintained at the required predetermined deflection angle in the first state stage T1 and the second state stage T2, thereby achieving precise and stable phase change.

In addition, the specific voltage values of the auxiliary voltage V1, the first drive voltage V21, and the second drive voltage V22 may be set according to actual requirements. For example, when the phase of the phase shifter is stable, the required drive voltage values corresponding to different deflection states of the liquid crystal molecule may be inversely deduced according to the actually measured phase. After the drive voltage values corresponding to all deflection states of the liquid crystal molecule are acquired, during the process of driving the liquid crystal molecule to perform a deflection state transition, a group of auxiliary voltages may be arbitrarily set, the acceleration abilities of the auxiliary voltages may be evaluated according to the actually measured duration required for the phase shifter to complete the phase change, and further, an auxiliary voltage which is the most suitable for achieving the current deflection state transition is selected by comparing the test results under different auxiliary voltages. Finally, the above-described test procedure is repeated for each expected deflection state transition to obtain the optimum auxiliary voltage corresponding to each deflection state transition, and the embodiments of the present disclosure do not make any specific limitations in this regard.

With continued reference to FIGS. 12 to 14, optionally, the larger the difference between the first included angle θ1 and the second included angle θ2 is, the longer the duration of the state switching stage T0 is.

When the phase shifter is switched from the first state stage T1 to the second state stage T2, it takes a certain time for the liquid crystal molecule 230 to be deflected, and the time depends on the angle by which the liquid crystal molecule 230 needs to be deflected.

In the embodiments, the difference between the first included angle θ1 and the second included angle θ2 refers to an angle by which the liquid crystal molecule 230 needs to be deflected when the phase shifter is switched from the first state stage T1 to the second state stage T2. The larger the difference between the first included angle θ1 and the second included angle θ2 is, the larger the angle by which the liquid crystal molecule 230 needs to be deflected, and accordingly, the response duration for the phase shifter to be switched from the first state stage T1 to the second state stage T2 becomes longer.

When the phase shifter is switched from the first state stage T1 to the second state stage T2, the angle by which the liquid crystal molecule 230 needs to be deflected is small if the difference between the first included angle θ1 and the second angle θ2 is relatively small, so the deflection process will be completed in a relatively short time. In this case, the state switching stage T0 is set to have a relatively short duration to avoid unnecessary phase changes caused when the holding duration of the electric field force generated by the auxiliary electrode 22 is too long and the liquid crystal molecule 230 is overly deflected, thereby facilitating the improvement of the precision of the beam pointing.

The angle by which the liquid crystal molecule 230 needs to be deflected is relatively large if the difference between the first included angle θ1 and the second angle θ2 is relatively large, so the deflection process will be completed in a relatively long time. In this case, the state switching stage T0 is set to have a relatively long duration to prevent the deflection from being insufficiently accelerated when the holding duration of the electric field force generated by the auxiliary electrode 22 is too short, thereby ensuring that the liquid crystal molecule 230 can reach the required deflection angle in a shorter time.

It is to be noted that the specific value of the difference between the first included angle θ1 and the second angle θ2 may be set according to actual requirements, and the embodiments of the present disclosure do not make any specific limitations in this regard.

With continued reference to FIGS. 1 to 3 and 8 to 11, optionally, the auxiliary electrode 22 includes a first electrode 221 and a second electrode 222. In the direction perpendicular to the plane on which the first substrate 11 is located, the first electrode 221 and the second electrode 222 are located on the same side of the liquid crystal layer 23. When the auxiliary electrode 22 drives the liquid crystal molecule 230 to be deflected in the first direction X, the first electrode 221 is configured to receive a first auxiliary voltage, the second electrode 222 is configured to receive a second auxiliary voltage, and the first auxiliary voltage is different from the second auxiliary voltage.

Specifically, as shown in FIGS. 1 to 3 and 8 to 11, the first electrode 221 and the second electrode 222 of the auxiliary electrode 22 are located on the same side of the liquid crystal layer 23. When the auxiliary electrode 22 is required to form the transverse electric field 31 in the liquid crystal layer 23 to drive the liquid crystal molecule 230 in the liquid crystal layer 23 to be deflected in the first direction X by the electric field force generated by the auxiliary electrode 22 (for example, in the state switching stage T0), the transverse electric field 31 which is substantially parallel to the first substrate 11 is generated between the first electrode 221 and the second electrode 222 by applying the first auxiliary voltage to the first electrode 221 and applying the second auxiliary voltage to the second electrode 222, where the first auxiliary voltage is different from the second auxiliary voltage, so that the speed at which the liquid crystal molecule 230 in the liquid crystal layer 23 is deflected in the first direction X is increased by the electric field force generated by the auxiliary electrode 22, thereby increasing the speed of beam steering and improving the tracking performance of the antenna.

With continued reference to FIGS. 12 to 14, optionally, the larger the difference between the first included angle θ1 and the second included angle θ2 is, the larger the voltage difference between the first auxiliary voltage and the second auxiliary voltage is.

As described above, the difference between the first included angle θ1 and the second included angle θ2 refers to an angle by which the liquid crystal molecule 230 needs to be deflected when the phase shifter is switched from the first state stage T1 to the second state stage T2. The larger the difference between the first included angle θ1 and the second included angle θ2 is, the larger the angle by which the liquid crystal molecule 230 needs to be deflected, and accordingly, the response duration for the phase shifter to be switched from the first state stage T1 to the second state stage T2 becomes longer.

In the embodiments, when the phase shifter is switched from the first state stage T1 to the second state stage T2, the angle by which the liquid crystal molecule 230 needs to be deflected is relatively small if the difference between the first included angle θ1 and the second angle θ2 is relatively small. In this case, the voltage difference between the first auxiliary voltage and the second auxiliary voltage is set to be relatively small, and thus the auxiliary electrode 22 can generate a relatively weak electric field force to avoid unnecessary phase changes caused when the electric field force generated by the auxiliary electrode 22 is too strong and the liquid crystal molecule 230 is overly deflected, thereby facilitating the improvement of the precision of the beam pointing.

The angle by which the liquid crystal molecule 230 needs to be deflected is relatively large if the difference between the first included angle θ1 and the second angle θ2 is relatively large. In this case, the voltage difference between the first auxiliary voltage and the second auxiliary voltage is set to be relatively large, and thus the auxiliary electrode 22 can generate a relatively strong electric field force to better drive the liquid crystal molecule 230 to be deflected at a relatively large deflection angle and prevent the deflection from being insufficiently accelerated when the electric field force generated by the auxiliary electrode 22 is too weak, thereby ensuring that the liquid crystal molecule 230 can reach the required deflection angle in a relatively short time.

With continued reference to FIGS. 1 to 3, optionally, the first electrode 221 and the second electrode 222 are located on two sides of the microstrip line 21 in a third direction 21, respectively. The third direction P is parallel to the plane on which the first substrate 11 is located and perpendicular to the extension direction of the microstrip line 21.

The extension direction of the microstrip line 21 may also be understood as the transmission direction of the radio frequency signal on the microstrip line 21.

Specifically, as shown in FIG. 9, the microstrip line 21 is located between the first electrode 221 and the second electrode 222 in the third direction P. The transverse electric field 31 passing through the liquid crystal layer 23 below the microstrip line 21 is formed by applying the first auxiliary voltage and the second auxiliary voltage to the first electrode 221 and the second electrode 222 respectively so that the liquid crystal molecule 230 located below the microstrip line 21 is deflected. The radio frequency signal is also mainly transmitted in the liquid crystal layer 23 below the microstrip line 21. Therefore, by disposing the first electrode 221 and the second electrode 222 on two sides of the microstrip line 21 in the third direction P, respectively, the liquid crystal molecule 230 driven to be deflected by the transverse electric field 31 formed by the first electrode 221 and the second electrode 222 may be enabled to be located mainly on a transmission path of the radio frequency signal to increase the impact of the liquid crystal molecule 230 whose deflection is accelerated on the phase of the radio frequency signal, thereby achieving a more precise phase change in a relatively short time.

It is to be noted that the third direction P is a direction perpendicular to the transmission direction of the radio frequency signal on the microstrip line 21 or the third direction P is a direction perpendicular to the extension direction of the microstrip line 21.

With continued reference to FIG. 2, optionally, the spacing between the first electrode 221 and the second electrode 222 in the third direction P is L1, and L1≤6*L0, where L0 is the line width of the microstrip line 21.

In the case where the auxiliary voltage applied to the auxiliary electrode 22 remains unchanged, a stronger transverse electric field may be formed when the spacing L1 between the first electrode 221 and the second electrode 222 is relatively small, and thus a stronger electric field force is provided to drive the liquid crystal molecule 230 to be deflected in the first direction X, thereby improving the deflection efficiency of the liquid crystal molecule 230. In this manner, the liquid crystal molecule 230 may complete the deflection process more quickly to reduce the response duration of the phase shifter, thereby increasing the speed of beam steering and improving the tracking performance of the antenna.

In the embodiments, by setting the spacing L1 between the first electrode 221 and the second electrode 222 to be less than or equal to 6 times the line width L0 of the microstrip line 21 to ensure that the spacing L1 between the first electrode 221 and the second electrode 222 is not too large, the auxiliary electrode 22 can provide a sufficiently strong electric field force to increase the speed of the deflection of the liquid crystal molecule 230 in the first direction X under the condition of no significant increase in power consumption, thereby reducing the response duration of the phase shifter.

With continued reference to FIGS. 3 and 9, optionally, the spacing between the first electrode 221 and the microstrip line 21 in the third direction P is L2, the spacing between the second electrode 222 and the microstrip line 21 in the third direction P is L3, and L2=L3.

As shown in FIG. 9, by setting the spacing L2 between the first electrode 221 and the microstrip line 21 to be equal to the spacing L3 between the second electrode 222 and the microstrip line 21, the first electrode 221 and the second electrode 222 are symmetrically disposed relative to the microstrip line 21. When the first auxiliary voltage and the second auxiliary voltage are applied to the first electrode 221 and the second electrode 222, respectively, the transverse electric field 31 formed by the first electrode 221 and the second electrode 222 is also symmetrically distributed on two sides of the microstrip line 21 so that the transverse electric field 31 can provide a more uniform transverse electric field force for the liquid crystal molecules 230 below the microstrip line 21. In this manner, the liquid crystal molecules 230 below the microstrip line 21 are uniformly deflected, and the liquid crystal molecules 230 in the region below the microstrip line 21 can complete the deflection synchronously. Since the liquid crystal layer 23 below the microstrip line 21 is the main transmission path of the radio frequency signal, the uniform deflection of the liquid crystal molecules 230 below the microstrip line 21 can ensure that the radio frequency signal undergoes a relatively consistent phase change in the transmission process, thereby achieving a more precise phase control.

It is to be noted that, in other embodiments, the spacing L2 between the first electrode 221 and the microstrip line 21 may not be equal to the spacing L3 between the second electrode 222 and the microstrip line 21, and the embodiments of the present disclosure do not make any specific limitations in this regard.

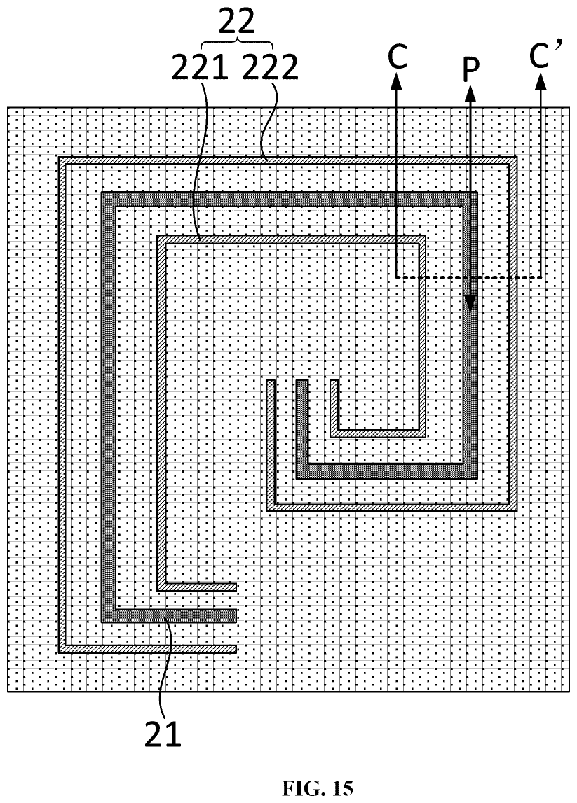

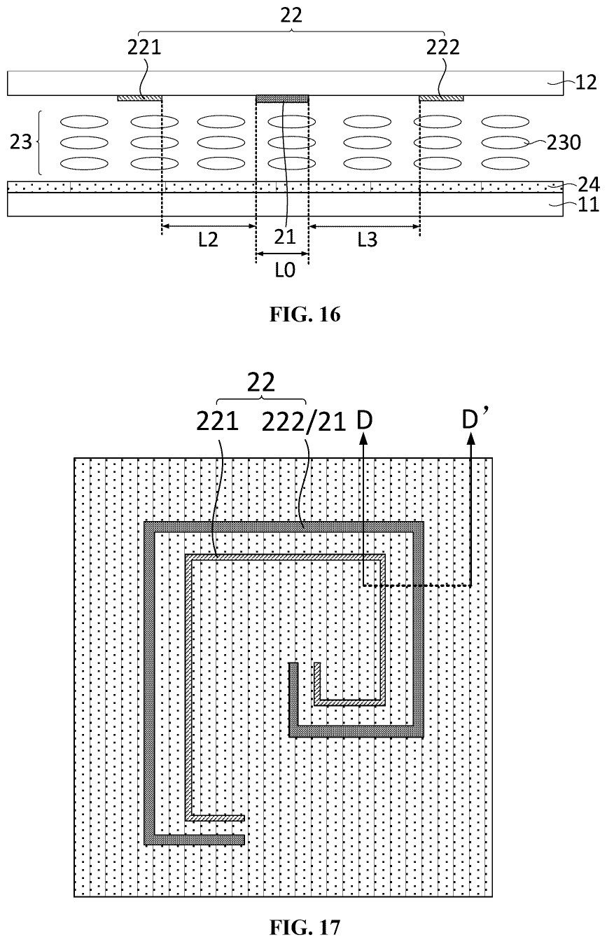

FIG. 15 is a partial structure view of a phase shifter according to one or more embodiments of the present disclosure, and FIG. 16 is a sectional view taken along C-C′ in FIG. 15. As shown in FIGS. 15 and 16, optionally, the spacing between the first electrode 221 and the microstrip line 21 in the third direction P is L2, the spacing between the second electrode 222 and the microstrip line 21 in the third direction P is L3, L0≤L2≤3*L0, and L0≤L3≤3*L0, where L0 is the line width of the microstrip line 21.

As shown in FIGS. 15 and 16, by setting both the spacing L2 between the first electrode 221 and the microstrip line 21 and the spacing L3 between the second electrode 222 and the microstrip line 21 to be larger than the line width L0 of the microstrip line 21, the coupling capacitance between the first electrode 221 and the microstrip line 21 and the coupling capacitance between the second electrode 222 and the microstrip line 21 can be lowered, thereby reducing the impact of the coupling capacitance on the radio frequency signal transmitted on the microstrip line 21 and achieving a more precise phase control.

Further, as shown in FIG. 16, by setting both the spacing L2 between the first electrode 221 and the microstrip line 21 and the spacing L3 between the second electrode 222 and the microstrip line 21 to be less than three times the line width L0 of the microstrip line 21 to ensure that the distance between the first electrode 221 and the microstrip line 21 and the distance between the second electrode 222 and the microstrip line 21 are not too large, the first electrode 221 and the second electrode 222 can provide a sufficiently strong electric field force for the liquid crystal layer 23 below the microstrip line 21 to increase the speed of the deflection of the liquid crystal molecule 230 in the first direction X under the condition of no significant increase in power consumption, thereby reducing the response duration of the phase shifter. Moreover, the arrangement of the first electrode 221 and the second electrode 222 becomes more compact, thereby reducing the volume of the phase shifter.

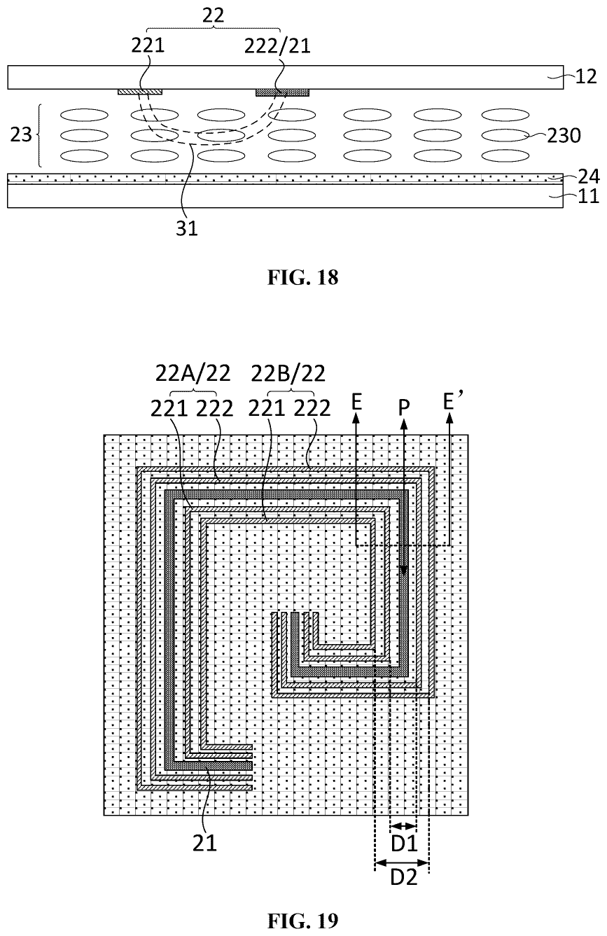

FIG. 17 is a partial structure view of another phase shifter according to one or more embodiments of the present disclosure, and FIG. 18 is a sectional view taken along D-D′ in FIG. 17. As shown in FIGS. 17 and 18, optionally, the second electrode 222 and the microstrip line 21 are the same electrode structure.

Specifically, as shown in FIGS. 17 and 18, the microstrip line 21 may be reused as the second electrode 222. When the auxiliary electrode 22 is required to drive the liquid crystal molecule 230 in the liquid crystal layer 23 to be deflected in the first direction X (for example, in the state switching stage T0), the transverse electric field 31 may be formed in the liquid crystal layer 23 between the first electrode 221 and the microstrip line 21 (that is, the second electrode 222) by applying the first auxiliary voltage to the first electrode 221 and applying the second auxiliary voltage to the microstrip line 21 (that is, the second electrode 222), where the first auxiliary voltage is different from the second auxiliary voltage, so that the speed at which the liquid crystal molecule 230 in the liquid crystal layer 23 is deflected in the first direction X is increased by the electric field force generated by the auxiliary electrode 22, thereby increasing the speed of beam steering.

By reusing the microstrip line 21 as the second electrode 222, the electrode structure can be simplified, thereby reducing the volume of the phase shifter.

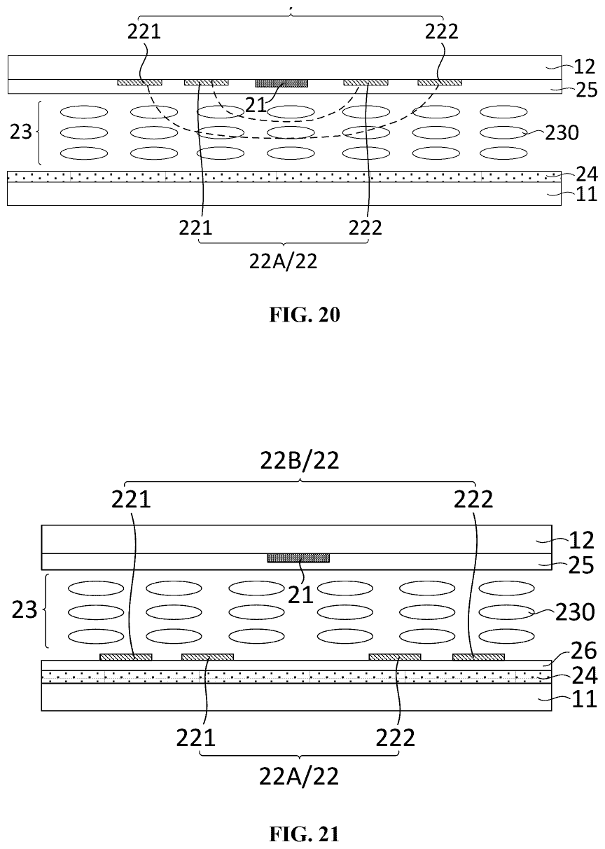

FIG. 19 is a partial structure view of another phase shifter according to one or more embodiments of the present disclosure, and FIG. 20 is a sectional view taken along E-E′ in FIG. 19. As shown in FIGS. 19 and 20, optionally, the auxiliary electrode 22 includes a first auxiliary electrode 22A and a second auxiliary electrode 22B. The first auxiliary electrode 22A and the second auxiliary electrode 22B are located on the same side of the liquid crystal layer 23, and the first auxiliary electrode 22A is insulated from the second auxiliary electrode 22B. In a direction parallel to the plane on which the first substrate 11 is located, the distance between a first electrode 221 of the first auxiliary electrode 22A and a second electrode 222 of the first auxiliary electrode 22A is a first distance D1, and the distance between a first electrode 221 of the second auxiliary electrode 22B and a second electrode 222 of the second auxiliary electrode 22B is a second distance D2, where the first distance D1 is shorter than the second distance D2.

As shown in FIGS. 19 and 20, at least two auxiliary electrodes 22 may be disposed on the same side of the liquid crystal layer 23, and different auxiliary electrodes 22 are insulated from each other, thereby increasing the coverage area of the electric field formed by the auxiliary electrodes 22. The directions of the electric field and the strength of the electric field in the different regions can also be adjusted more flexibly by applying different auxiliary voltages to the different auxiliary electrodes 22, thereby more precisely driving the liquid crystal molecule to be deflected.

Specifically, as shown in FIGS. 19 and 20, two auxiliary electrodes 22 being disposed on the same side of the liquid crystal layer 23 are taken as an example for illustration. The two auxiliary electrodes 22 are a first auxiliary electrode 22A and a second auxiliary electrode 22B, respectively. The first electrode 221 and the second electrode 222 of the first auxiliary electrode 22A are disposed on two sides of the microstrip line 21 in the third direction P, respectively, the first electrode 221 and the second electrode 222 of the second auxiliary electrode 22B are disposed on two sides of the microstrip line 21 in the third direction P, respectively, and the first auxiliary electrode 22A and the second auxiliary electrode 22B are insulated from each other.

In the direction parallel to the plane on which the first substrate 11 is located, the first auxiliary electrode 22A is disposed between the first electrode 221 and the second electrode 222 of the second auxiliary electrode 22B. In this manner, the first distance D1 between the first electrode 221 and the second electrode 222 of the first auxiliary electrode 22A is relatively short so that the first auxiliary electrode 22A can form a relatively strong local transverse electric field in a region closer to the microstrip line 21, thereby more precisely controlling the deflection of the liquid crystal molecules 230 in the vicinity of the microstrip line 21. Moreover, the second distance D2 between the first electrode 221 and the second electrode 222 of the second auxiliary electrode 22B is relatively long so that the second auxiliary electrode 22B can form a transverse electric field in a larger region, thereby increasing the coverage area of the transverse electric field formed by the auxiliary electrode 22 and enabling the transverse electric field to be distributed in a larger region.

Further, by applying different auxiliary voltages to the first auxiliary electrode 22A and the second auxiliary electrode 22B that are different from each other, respectively, the direction of the electric field and the strength of the electric field in the different regions can be adjusted more flexibly. Through the cooperation of the first auxiliary electrode 22A and the second auxiliary electrode 22B, a more precise control of the electric field is achieved, thereby achieving a more precise phase change.

It is to be noted that the spacing between the electrodes of the auxiliary electrode 22 and the spacing between each of the electrodes and the microstrip line 21 may be set according to actual requirements, and the embodiments of the present disclosure do not make any specific limitations in this regard.

In addition, the line width of each of the electrodes of the auxiliary electrode 22 may be set according to actual requirements, and the embodiments of the present disclosure do not make any specific limitations in this regard.

Optionally, when the auxiliary electrode 22 drives the liquid crystal molecule 230 to be deflected in the first direction X, the voltage difference between a first auxiliary voltage received by the first auxiliary electrode 22A and a second auxiliary voltage received by the first auxiliary electrode 22A is less than the voltage difference between a first auxiliary voltage received by the second auxiliary electrode 22B and a second auxiliary voltage received by the second auxiliary electrode 22B.

As described above, when the auxiliary electrode 22 drives the liquid crystal molecule 230 to be deflected in the first direction X, for example, in the state switching stage T0, the transverse electric field 31 is formed in the liquid crystal layer 23 between the first electrode 221 and the second electrode 222 by applying the first auxiliary voltage to the first electrode 221 and applying the second auxiliary voltage to the second electrode 222, where the first auxiliary voltage is different from the second auxiliary voltage, so that the speed at which the liquid crystal molecule 230 in the liquid crystal layer 23 is deflected in the first direction X is increased by the electric field force generated by the auxiliary electrode 22, thereby increasing the speed of beam steering.

The strength of the transverse electric field formed by the auxiliary electrode 22 is related to the voltage difference between the first auxiliary voltage received by the first electrode 221 of the auxiliary electrode 22 and the second auxiliary voltage received by the second electrode 222 of the auxiliary electrode 22 and the spacing between the first electrode 221 and the second electrode 222.

Specifically, the larger the voltage difference between the first auxiliary voltage received by the first electrode 221 of the auxiliary electrode 22 and the second auxiliary voltage received by the second electrode 222 of the auxiliary electrode 22 is, the stronger the transverse electric field formed by the auxiliary electrode 22 is.

Under the condition that the voltage difference between the first auxiliary voltage received by the first electrode 221 of the auxiliary electrode 22 and the second auxiliary voltage received by the second electrode 222 of the auxiliary electrode 22 is constant, the smaller the spacing between the first electrode 221 and the second electrode 222 is, the stronger the transverse electric field formed by the auxiliary electrode 22 is.

In the embodiments, the first distance D1 between the first electrode 221 and the second electrode 222 of the first auxiliary electrode 22A is relatively short, and the second distance D2 between the first electrode 221 and the second electrode 222 of the second auxiliary electrode 22B is relatively long. By setting the voltage difference between the first auxiliary voltage received by the first electrode 221 of the first auxiliary electrode 22A and the second auxiliary voltage received by the second electrode 222 of the first auxiliary electrode 22A to be relatively small and the voltage difference between the first auxiliary voltage received by the first electrode 221 of the second auxiliary electrode 22B and the second auxiliary voltage received by the second electrode 222 of the second auxiliary electrode 22B to be relatively large, the strength of the transverse electric field formed by the first auxiliary electrode 22A and the strength of the transverse electric field formed by the second auxiliary electrode 22B can be more consistent in the region where the microstrip line 21 is located. In this manner, the electric field distribution in the region where the microstrip line 21 is located is more uniform, and thus the transverse electric field 31 can provide a more uniform transverse electric field force for the liquid crystal molecules 230 in the region where the microstrip line 21 is located, thereby achieving a uniform deflection of the liquid crystal molecules 230 in the region where the microstrip line 21 is located. Since the liquid crystal layer 23 in the region where the microstrip line 21 is located is the major transmission path of the radio frequency signal, the uniform deflection of the liquid crystal molecules 230 in the region where the microstrip line 21 is located can ensure that the radio frequency signal undergoes a relatively consistent phase change in the transmission process, thereby achieving a more precise phase control.

With continued reference to FIGS. 19 and 20, optionally, the first electrode 221 of the first auxiliary electrode 22A and the first electrode 221 of the second auxiliary electrode 22B are located on the same side of the microstrip line 21 in the third direction P, and the second electrode 222 of the first auxiliary electrode 22A and the second electrode 222 of the second auxiliary electrode 22B are located on the same side of the microstrip line 21 in the third direction P. The voltage difference between the first auxiliary voltage received by the first electrode 221 of the first auxiliary electrode 22A and the first auxiliary voltage received by the first electrode 221 of the second auxiliary electrode 22B is equal to the voltage difference between the second auxiliary voltage received by the second electrode 222 of the first auxiliary electrode 22A and the second auxiliary voltage received by the second electrode 222 of the second auxiliary electrode 22B.

By setting the voltage difference between the first auxiliary voltage received by the first electrode 221 of the first auxiliary electrode 22A and the first auxiliary voltage received by the first electrode 221 of the second auxiliary electrode 22B to be equal to the voltage difference between the second auxiliary voltage received by the second electrode 222 of the first auxiliary electrode 22A and the second auxiliary voltage received by the second electrode 222 of the second auxiliary electrode 22B, unnecessary mutual interference between the first auxiliary electrode 22A and the second auxiliary electrode 22B can be reduced, and the electric field distribution in the region where the microstrip line 21 is located can be more uniform to better control the deflection of the liquid crystal molecules 230, thereby achieving a more precise phase control.

For example, as shown in FIG. 20, the first auxiliary voltage received by the first electrode 221 of the second auxiliary electrode 22B is Uref, the first auxiliary voltage received by the first electrode 221 of the first auxiliary electrode 22A is Uref/2, the second auxiliary voltage received by the second electrode 222 of the first auxiliary electrode 22A is −Uref/2, and the second auxiliary voltage received by the second electrode 222 of the second auxiliary electrode 22B is −Uref. The first auxiliary voltage received by the first electrode 221 of the first auxiliary electrode 22A and the first auxiliary voltage received by the first electrode 221 of the second auxiliary electrode 22B are similar, and the second auxiliary voltage received by the second electrode 222 of the first auxiliary electrode 22A and the second auxiliary voltage received by the second electrode 222 of the second auxiliary electrode 22B are similar so that the transverse electric field formed by the first auxiliary electrode 22A and the transverse electric field formed by the second auxiliary electrode 22B are in the same direction. In this manner, unnecessary mutual interference between the first auxiliary electrode 22A and the second auxiliary electrode 22B can be reduced, thereby achieving a more precise phase control.

It is to be noted that the specific voltage values of the first auxiliary voltage and the second auxiliary voltage applied to the first auxiliary electrode 22A and the second auxiliary electrode 22B are not limited to the above embodiments, and the embodiments of the present disclosure do not make any specific limitations in this regard.

With continued reference to FIG. 20, optionally, the first auxiliary electrode 22A and the second auxiliary electrode 22B are disposed between the liquid crystal layer 23 and the second substrate 12.

FIG. 21 is a partial sectional view of another phase shifter according to one or more embodiments of the present disclosure. As shown in FIG. 21, optionally, the first auxiliary electrode 22A and the second auxiliary electrode 22B may be disposed between the liquid crystal layer 23 and the first substrate 11.

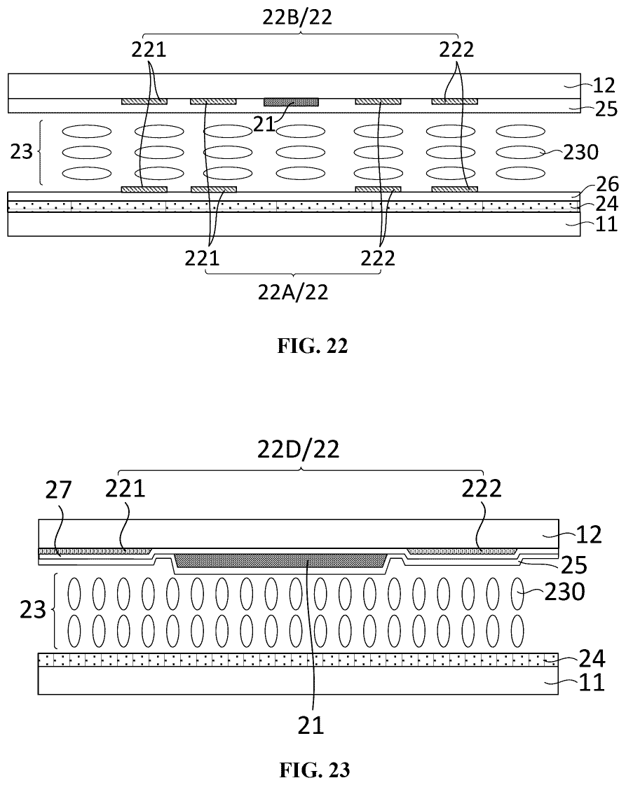

FIG. 22 is a partial sectional view of another phase shifter according to one or more embodiments of the present disclosure. As shown in FIG. 22, optionally, the first auxiliary electrode 22A and the second auxiliary electrode 22B may be disposed both between the liquid crystal layer 23 and the second substrate 12 and between the liquid crystal layer 23 and the first substrate 11, and the embodiments of the present disclosure do not make any specific limitations in this regard.

Optionally, the resistance of the auxiliary electrode 22 is larger than the resistance of the microstrip line 21.

By setting the resistance of the auxiliary electrode 22 to be larger than the resistance of the microstrip line 21, that is, by setting the auxiliary electrode 22 to have a relatively large resistance, the coupling capacitance between the auxiliary electrode 22 and the microstrip line 21 can be reduced, and thus the impact of the coupling capacitance on the radio frequency signal transmitted on the microstrip line 21 can be reduced, thereby achieving a more precise phase control.

Optionally, the material of the microstrip line 21 includes copper, and the material of the auxiliary electrode 22 includes copper or a metal oxide.

In the embodiments, the material of the microstrip line 21 includes a low-resistance metal such as copper so that the microstrip line 21 has a relatively small resistance, thereby facilitating the transmission of the radio frequency signal.

By setting the material of the auxiliary electrode 22 to include a high-resistance conductive material such as a metal oxide, the auxiliary electrode 22 has a relatively large resistance, the coupling capacitance between the auxiliary electrode 22 and the microstrip line 21 can be reduced, and thus the impact of the coupling capacitance on the radio frequency signal transmitted on the microstrip line 21 can be reduced, thereby achieving a more precise phase control.

The metal oxide may include indium tin oxide (ITO), indium-doped zinc oxide (IZO), zinc oxide (ZnO) or indium oxide (In₂O₃), and the embodiments of the present disclosure do not make any specific limitations in this regard.

In some embodiments, the material of the auxiliary electrode 22 may also be copper so that the auxiliary electrode 22 and the microstrip line 21 can be prepared in the same process, thereby shortening the preparation time.

With continued reference to FIGS. 1 to 3, optionally, the line width of the auxiliary electrode 22 is less than the line width of the microstrip line 21. In one aspect, by setting the line width of the microstrip line 21 to be relatively wide, the microstrip line 21 has a relatively small resistance, thereby facilitating the transmission of the radio frequency signal. In another aspect, by setting the line width of the auxiliary electrode 22 to be relatively narrow, the auxiliary electrode 22 has a relatively large resistance, the coupling capacitance between the auxiliary electrode 22 and the microstrip line 21 can be reduced, and thus the impact of the coupling capacitance on the radio frequency signal transmitted on the microstrip line 21 can be reduced, thereby achieving a more precise phase control.

It is to be noted that in other embodiments, the line width of the auxiliary electrode 22 may be greater than or equal to the line width of the microstrip line 21, which is not limited thereto.

The line width of the auxiliary electrode 22 may be optimized according to the required strength and distribution of the transverse electric field, the line width of the microstrip line 21 may be optimized according to the transmission performance of the radio frequency signal, and the embodiments of the present disclosure do not make any specific limitations in this regard.

In addition, in other embodiments, the resistance of the auxiliary electrode 22 may be enabled to be greater than the resistance of the microstrip line 21 in other manners. For example, the resistance of the auxiliary electrode 22 may be greater than the resistance of the microstrip line 21 by setting the thickness of the auxiliary electrode 22 to be smaller than the thickness of the microstrip line 21, thereby reducing the coupling capacitance between the auxiliary electrode 22 and the microstrip line 21 while ensuring the transmission performance of the radio frequency signal, and the embodiments of the present disclosure do not make any limitations in this regard.

With continued reference to FIGS. 8 to 11, optionally, the auxiliary electrode 22 includes a third auxiliary electrode 22C and/or a fourth auxiliary electrode 22D. The third auxiliary electrode 22C is located between the first substrate 11 and the liquid crystal layer 23, and the fourth auxiliary electrode 22D is located between the second substrate 12 and the liquid crystal layer 23.

As shown in FIGS. 8 and 9, only the fourth auxiliary electrode 22D may be disposed between the second substrate 12 and the liquid crystal layer 23, and the number of auxiliary electrodes can be reduced, thereby reducing the thickness of the phase shifter and reducing the cost.

As shown in FIG. 10, only the third auxiliary electrode 22C may be disposed between the first substrate 11 and the liquid crystal layer 23 to reduce the number of auxiliary electrodes, thereby reducing the thickness of the phase shifter and reducing the cost.

As shown in FIG. 11, the fourth auxiliary electrode 22D may be disposed between the second substrate 12 and the liquid crystal layer 23, and the third auxiliary electrode 22C may be disposed between the first substrate 11 and the liquid crystal layer 23. In this manner, the transverse electric field formed by the fourth auxiliary electrode 22D and the transverse electric field formed by the third auxiliary electrode 22C may be symmetrically disposed relative to the liquid crystal layer 23 in the direction perpendicular to the plane on which the first substrate 11 is located, thereby achieving a more uniform electric field distribution. Especially, in the case where the thickness of the liquid crystal layer 23 is thicker, the transverse electric field can be more uniformly distributed within the liquid crystal layer 23, thereby achieving the uniform deflection of the liquid crystal molecules 230 and achieving a more precise phase control.

The auxiliary electrodes 22 are disposed on two sides of the liquid crystal layer 23 in the direction perpendicular to the plane on which the first substrate 11 is located. In this manner, under the joint action of the electric field forces on two sides of the liquid crystal layer 23, the speed of the deflection of the liquid crystal molecule 230 in the first direction X can be increased, and the response duration of the deflection of the liquid crystal molecule 230 in the first direction X can be reduced, thereby increasing the speed of beam steering and improving the tracking performance of the antenna.

With continued reference to FIGS. 10 and 11, optionally, the third auxiliary electrode 22C is insulated from the grounding metal layer 24.

Since both the third auxiliary electrode 22C and the grounding metal layer 24 are disposed on the first substrate 11, by setting the third auxiliary electrode 22C to be insulated from the grounding metal layer 24, a short circuit between the third auxiliary electrode 22C and the grounding metal layer 24 is avoided, thereby keeping the normal operation of the phase shifter from being affected.

With continued reference to FIGS. 10 and 11, optionally, the third auxiliary electrode 22C is located on a side of the grounding metal layer 24 facing the liquid crystal layer 23, and a first insulating layer 26 is disposed between the third auxiliary electrode 22C and the grounding metal layer 24.

As shown in FIGS. 10 and 11, by setting the third auxiliary electrode 22C to be located on a side of the grounding metal layer 24 facing the liquid crystal layer 23, the grounding metal layer 24 can be prevented from having a shielding effect on the transverse electric field formed by the third auxiliary electrode 22C, thereby ensuring that the transverse electric field formed by the third auxiliary electrode 22C can be acted effectively in the liquid crystal layer 23.

The third auxiliary electrode 22C may also be disposed closer to the liquid crystal layer 23, and thus the electric field strength of the transverse electric field formed by the third auxiliary electrode 22C within the liquid crystal layer 23 can be enhanced. In this manner, the speed of the deflection of the liquid crystal molecule 230 in the first direction X can be increased, and the response duration of the deflection of the liquid crystal molecule 230 in the first direction X can be reduced, thereby increasing the speed of beam steering and improving the tracking performance of the antenna.

Further, by setting the first insulating layer 26 between the third auxiliary electrode 22C and the grounding metal layer 24 to isolate the third auxiliary electrode 22C from the grounding metal layer 24, a short circuit between the third auxiliary electrode 22C and the grounding metal layer 24 is avoided.

The material of the first insulating layer 26 may be selected according to actual requirements, for example, an insulating material such as SiNx, and the embodiments of the present disclosure do not make any specific limitations in this regard.

With continued reference to FIGS. 9 and 11, optionally, the fourth auxiliary electrode 22D and the microstrip line 21 are located in the same layer.

As shown in FIGS. 9 and 11, by disposing the fourth auxiliary electrode 22D and the microstrip line 21 in the same layer, the number of layers of the phase shifter can be reduced, thereby reducing the thickness of the phase shifter and reducing the manufacturing cost and process complexity.

Further, when the fourth auxiliary electrode 22D and the microstrip line 21 are made of the same material, the fourth auxiliary electrode 22D and the microstrip line 21 can also be prepared in the same process, thereby shortening the preparation time and reducing the manufacturing cost.

FIG. 23 is a partial sectional view of another phase shifter according to one or more embodiments of the present disclosure. As shown in FIG. 23, optionally, the fourth auxiliary electrode 22D and the microstrip line 21 are located in different layers, and a second insulating layer 27 may be disposed between the fourth auxiliary electrode 22D and the microstrip line 21.

Specifically, as shown in FIG. 23, the fourth auxiliary electrode 22D and the microstrip line 21 may also be disposed in different layers. With the microstrip line 21 being disposed on a side of the fourth auxiliary electrode 22D facing the liquid crystal layer 23 as an example for illustration, the fourth auxiliary electrode 22D may be protected by disposing the second insulating layer 27 on a side of the fourth auxiliary electrode 22D facing the liquid crystal layer 23.

By disposing the microstrip line 21 on a side of the fourth auxiliary electrode 22D facing the liquid crystal layer 23, the microstrip line 21 may be disposed closer to the liquid crystal layer 23, and thus the electric field strength of the electric field formed by the microstrip line 21 within the liquid crystal layer 23 can be enhanced, thereby achieving a more precise phase change, which is not limited thereto.

For example, as shown in FIG. 23, during the preparation of the phase shifter, the fourth auxiliary electrode 22D may first be prepared on a side of the second substrate 12, the second insulating layer 27 may be prepared on a side of the fourth auxiliary electrode 22D facing away from the second substrate 12 to protect the fourth auxiliary electrode 22D, the microstrip line 21 may be prepared on a side of the second insulating layer 27 facing away from the second substrate 12, and the alignment layer 25 is prepared on a side of the microstrip line 21 facing away from the second substrate 12. The whole process may directly adopt a conventional process for preparing a liquid crystal panel, and such a process is mature and easy to implement.

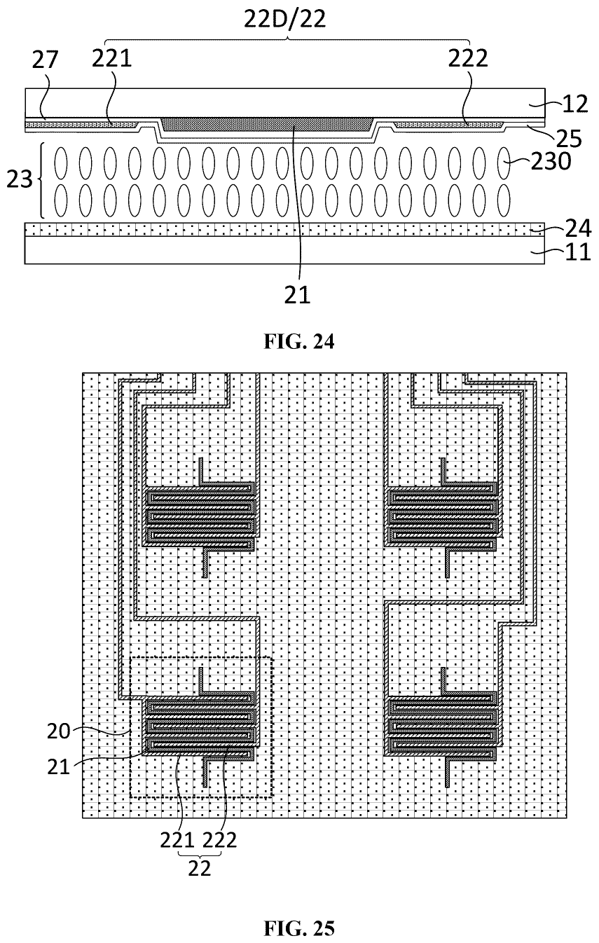

FIG. 24 is a partial sectional view of another phase shifter according to one or more embodiments of the present disclosure. As shown in FIG. 24, optionally, the fourth auxiliary electrode 22D may also be disposed on a side of the microstrip line 21 facing the liquid crystal layer 23 to dispose the fourth auxiliary electrode 22D closer to the liquid crystal layer 23, and thus the electric field strength of the transverse electric field formed by the fourth auxiliary electrode 22D within the liquid crystal layer 23 can be enhanced. In this manner, the speed of the deflection of the liquid crystal molecule 230 in the first direction X can be increased, and the response duration of the deflection of the liquid crystal molecule 230 in the first direction X can be reduced, thereby increasing the speed of beam steering and improving the tracking performance of the antenna. Further, by disposing the second insulating layer 27 on a side of the microstrip line 21 facing the liquid crystal layer 23, the microstrip line 21 can be protected to a certain extent, and the embodiments of the present disclosure do not make any specific limitations in this regard.

It is to be noted that the material of the second insulating layer 27 may be selected according to actual requirements, for example, an insulating material such as SiNx, and the embodiments of the present disclosure do not make any specific limitations in this regard.

With continued reference to FIG. 11, optionally, the auxiliary electrode 22 includes a first electrode 221 and a second electrode 222. In the direction perpendicular to the plane on which the first substrate 11 is located, the first electrode 221 and the second electrode 222 are located on the same side of the liquid crystal layer 23. The auxiliary electrode 22 includes a third auxiliary electrode 22C and a fourth auxiliary electrode 22D. In the direction perpendicular to the plane on which the first substrate 11 is located, a first electrode 221 of the third auxiliary electrode 22C at least partially overlaps a first electrode 221 of the fourth auxiliary electrode 22D. In the direction perpendicular to the plane on which the first substrate 11 is located, a second electrode 222 of the third auxiliary electrode 22C at least partially overlaps a second electrode 222 of the fourth auxiliary electrode 22D.

Specifically, as shown in FIG. 11, in the direction perpendicular to the plane on which the first substrate 11 is located, by setting the first electrode 221 of the third auxiliary electrode 22C to at least partially overlap the first electrode 221 of the fourth auxiliary electrode 22D and setting the second electrode 222 of the third auxiliary electrode 22C to at least partially overlap the second electrode 222 of the fourth auxiliary electrode 22D, the transverse electric field formed by the third auxiliary electrode 22C and the transverse electric field formed by the fourth auxiliary electrode 22D are superimposed, and thus the strength of the transverse electric field within the liquid crystal layer 23 can be enhanced. In this manner, the liquid crystal molecule 230 can be driven to be deflected in the first direction X faster, and the response duration of the deflection of the liquid crystal molecule 230 in the first direction X can be reduced, thereby increasing the speed of beam steering and improving the tracking performance of the antenna.

The superimposed electric field formed by the third auxiliary electrode 22C and the fourth auxiliary electrode 22D can be more uniformly distributed within the liquid crystal layer 23, thereby achieving the uniform deflection of the liquid crystal molecules 230 and achieving a more precise phase control.

Optionally, the first auxiliary voltage received by the first electrode 221 of the third auxiliary electrode 22C and the first auxiliary voltage received by the first electrode 221 of the fourth auxiliary electrode 22D are the same, and the second auxiliary voltage received by the second electrode 222 of the third auxiliary electrode 22C and the second auxiliary voltage received by the second electrode 222 of the fourth auxiliary electrode 22D are the same.

By setting the first auxiliary voltage received by the third auxiliary electrode 22C to be the same as the first auxiliary voltage received by the fourth auxiliary electrode 22D and the second auxiliary voltage received by the third auxiliary electrode 22C to be the same as the second auxiliary voltage received by the fourth auxiliary electrode 22D, the transverse electric field formed by the third auxiliary electrode 22C and the transverse electric field formed by the fourth auxiliary electrode 22D within the liquid crystal layer 23 can have the same electric field direction and the same electric field strength. In this manner, unnecessary mutual interference between the third auxiliary electrode 22C and the fourth auxiliary electrode 22D can be reduced, and the electric field distribution in the region where the microstrip line 21 is located can be more uniform to better control the deflection of the liquid crystal molecules 230, thereby achieving a more precise phase control.

Meanwhile, the voltage control strategy can also be simplified without the need to control the voltage of each electrode separately, and the complexity of wires can be reduced, thereby simplifying the manufacturing process, reducing the cost, and facilitating implementation and debugging.

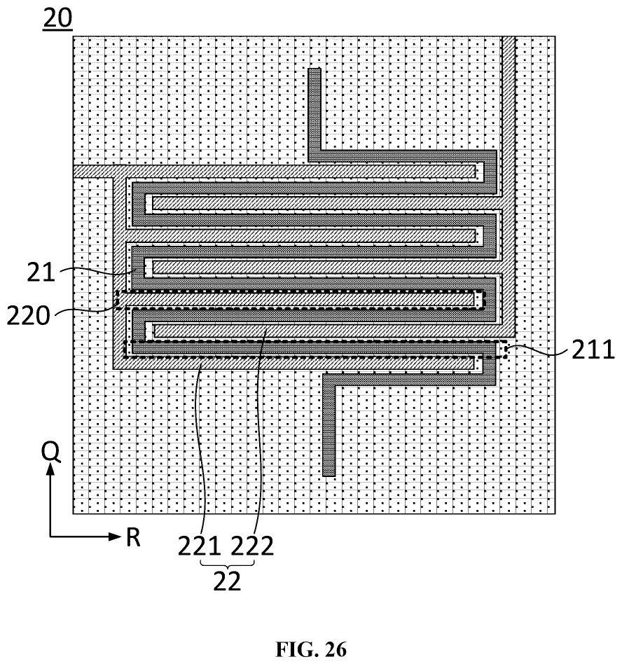

FIG. 25 is a partial structure view of another phase shifter according to one or more embodiments of the present disclosure, and FIG. 26 is a structure view of a phase shift unit according to one or more embodiments of the present disclosure. As shown in FIGS. 25 and 26, optionally, the microstrip line 21 has a serpentine structure. The serpentine structure includes multiple wire divisions 211 which are connected in sequence. The wire divisions 211 are arranged in a fourth direction Q and extend in a fifth direction R, and the auxiliary electrodes 22 are disposed between adjacent wire divisions 211, where the fourth direction Q and the fifth direction R are parallel to the plane on which the first substrate 11 is located, and the fourth direction Q intersects the fifth direction R.

For example, as shown in FIGS. 25 and 26, the microstrip line 21 has a serpentine structure, and multiple wire divisions 211 of the serpentine structure are arranged in the fourth direction Q and extend in the fifth direction R. The auxiliary electrode 22 may be set as a comb-tooth electrode, and the comb-tooth electrode includes multiple strip-shaped branch electrodes 220. The strip-shaped branch electrodes 220 are also arranged in the fourth direction Q and extend in the fifth direction R. The strip-shaped branch electrodes 220 are located between adjacent wire divisions 211 so that the auxiliary electrode 22 forms a transverse electric field that drives the liquid crystal molecule 230 to be deflected. The transverse electric field passes through the liquid crystal layer 23 in the region where the microstrip line 21 is located. In this manner, the speed of the deflection of the liquid crystal molecule 230 in the first direction X can be increased, and the response duration of the deflection of the liquid crystal molecule 230 in the first direction X can be reduced, thereby increasing the speed of beam steering and improving the tracking performance of the antenna.

The serpentine structure and the comb-tooth electrode mesh with each other, and the structure is compact, thereby making full use of the space of the phase shifter and achieving the miniaturization of the phase shifter.

It is to be noted those skilled in the art can arbitrarily set the shape of the microstrip line 21 according to actual requirements. For example, as shown in FIGS. 1 to 3, the microstrip line 21 may be hollow square-shaped, or as shown in FIG. 25, the shape of the microstrip line 21 may be serpentine. In other embodiments, the shape of the microstrip line 21 may be U-shaped, W-shaped, comb-tooth-shaped or spiral. The shape of the auxiliary electrode 22 may be adaptively set according to the shape of the microstrip line 21. The embodiments of the present disclosure do not make any specific limitations in this regard.

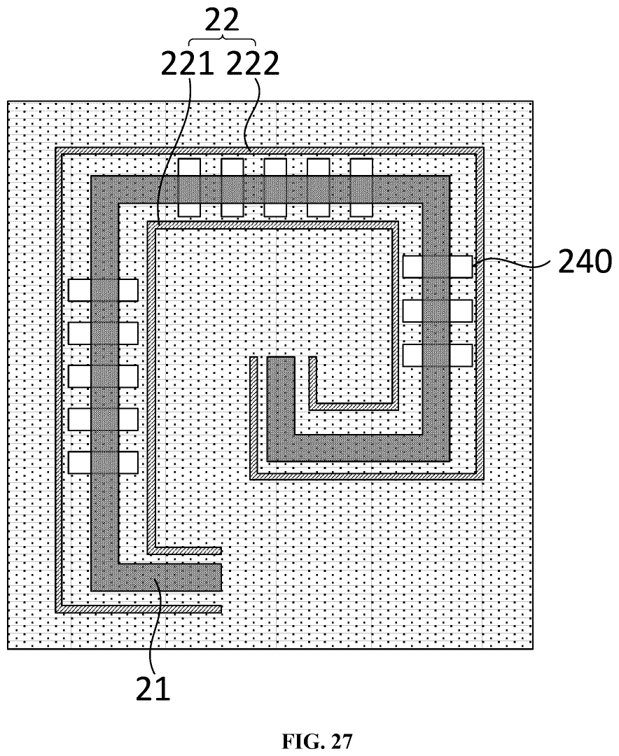

FIG. 27 is a partial structure view of another phase shifter according to one or more embodiments of the present disclosure. As shown in FIG. 27, optionally, the grounding metal layer 24 includes an opening 240. The opening 240 at least partially overlaps the microstrip line 21 in the direction perpendicular to the plane on which the first substrate 11 is located, thereby forming a defected ground structure (DGS). By etching the set opening 240 on the grounding metal layer 24 which serves as a grounding plane, the distribution of inductance and capacitance in the microstrip line 21 can be altered to obtain a larger base phase difference.

For example, as shown in FIG. 27, in the direction perpendicular to the plane on which the first substrate 11 is located, the portion where the microstrip line 21 overlaps the grounding metal layer 24 may be equivalent to a capacitance, the portion where the microstrip line 21 overlaps the opening 240 may be equivalent to an inductance, and thus a capacitance-inductance-capacitance (CLC) resonance structure is formed. The CLC resonance structure can slow down the phase speed of the radio frequency signal in a short physical interval, thereby achieving a phase shift function.

Further, by changing the deflection angle of the liquid crystal molecule 230 in the liquid crystal layer 23, the dielectric constant of the liquid crystal layer 23 can be adjusted, and thus the degree to which the phase speed of the radio frequency signal is slowed down can be changed, thereby achieving the precise regulation of the phase of the radio frequency signal.

The phase shifter provided by the embodiments of the present disclosure has a compact structure, occupies a small space, and is easy to integrate into an antenna system. Moreover, the phase shifter has the advantages of high phase resolution, good control precision, and fast response speed and thus can be applied to occasions requiring dynamic adjustment of the phase distribution of the antenna array, such as beamforming, multi-target tracking, and the like.

Based on the same inventive concept, the embodiments of the present disclosure further provide an antenna. The antenna includes the phase shifter described in any of the embodiments of the present disclosure. Therefore, the antenna provided by the embodiments of the present disclosure has the effects of the solutions of any of the embodiments described above, and the structures and terms that are the same as or correspond to those in the above embodiments are not re-explained here.

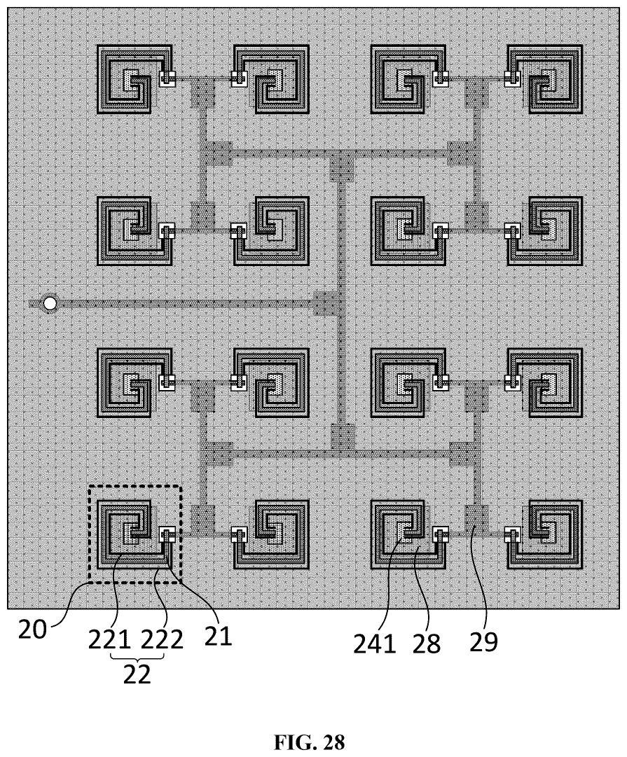

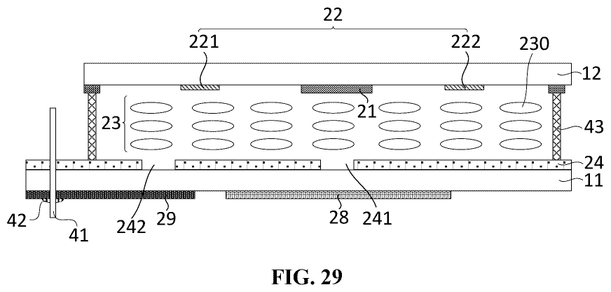

FIG. 28 is a structure view of an antenna according to one or more embodiments of the present disclosure, and FIG. 29 is a partial sectional view of an antenna according to one or more embodiments of the present disclosure. As shown in FIGS. 28 and 29, optionally, the antenna provided by the embodiments of the present disclosure further includes a radiation electrode 28. The radiation electrode 28 is located on a side of the first substrate 11 facing away from the grounding metal layer 24. The grounding metal layer 24 includes a first hollow portion 241. The radiation electrode 28 covers the first hollow portion 241 in a direction perpendicular to the first substrate 11.

Specifically, as shown in FIGS. 28 and 29, the grounding metal layer 24 is provided with a first hollow portion 241. The vertical projection of the radiation electrode 28 on a plane on which the grounding metal layer 24 is located covers the first hollow portion 241. The radio frequency signal is transmitted between the microstrip line 21 and the grounding metal layer 24 and is phase-shifted by the liquid crystal layer 23 between the microstrip line 21 and the grounding metal layer 24 to change the phase of the radio frequency signal. The phase-shifted radio frequency signal is coupled to the radiation electrode 28 at the first hollow portion 241 of the grounding metal layer 24, and the radiation electrode 28 radiates the signal outward. The specific parameters of the first hollow portion 241, such as the diameter of the first hollow portion 241, may be set according to the actual situation, and the embodiments of the present disclosure do not make any specific limitations in this regard.

It is to be noted that by setting the vertical projection of the radiation electrode 28 to cover the first hollow portion 241, the phase-shifted radio frequency signal is enabled to pass through the first hollow portion 241 and arrive at the radiation electrode 28 above, thereby ensuring that the radio frequency signal is radiated outward.

In addition, the radiation electrode 28 may be disposed correspondingly to the phase shift unit 20. For example, the radiation electrodes 28 and the phase shift units 20 are disposed in a one-to-one correspondence, and the radiation electrodes 28 corresponding to different phase shift units 20 are insulated from each other.

In other embodiments, the radiation electrode 28 may also be located on a side of the second substrate 12 facing away from the microstrip line 21, that is, the phase shifter is set in a flip configuration, and the embodiments of the present disclosure do not make any specific limitations in this regard.

With continued reference to FIGS. 28 and 29, optionally, the antenna 100 provided by the embodiments of the present disclosure further includes a feed network 29. The feed network 29 and the radiation electrode 28 may be disposed in the same layer.

The feed network 29 is configured to transmit the radio frequency signals to the phase shift units 20. The feed network 29 may be distributed in a dendritic shape and include multiple branches, and one branch provides the radio frequency signal for one phase shift unit 10. As shown in FIG. 29, the feed network 29 and the radiation electrode 28 may be disposed in the same layer, that is, the feed network 29 is disposed co-planar to the radiation electrode 28. In this case, the feed network 29 and the microstrip line 21 are located in different layers. The grounded metal layer 24 may be provided with a second hollow portion 242. The vertical projection of the feed network 29 on the plane on which the grounding metal layer 24 is located at least partially overlaps the second hollow portion 242 to enable the radio frequency signal transmitted from the feed network 29 to be coupled to the microstrip line 21 at the second hollow portion 242 of the grounding metal layer 24. The dielectric constant of the liquid crystal layer 23 is changed by controlling the deflection of the liquid crystal molecule 230 in the liquid crystal layer 23, thereby achieving the phase shifting of the radio frequency signal on the microstrip line 21.

It is to be noted that, in the embodiments, by disposing the feed network 29 and the radiation electrode 28 in the same layer, the feed network 29 and the microstrip line 21 may be separated from each other, thereby preventing the voltage signals transmitted in the microstrip line 21 from cross-talking among the phase shift units 20 and enhancing the operational reliability of the antenna.

In other embodiments, the feed network 29 and the microstrip line 21 may also be disposed in the same layer, that is, the feed network 29 is disposed co-planar to the microstrip line 21. In this case, the feed network 29 is coupled to the microstrip line 21. Compared to the radio frequency signal transmitted by the feed network 29 being coupled to the microstrip line 21 through the liquid crystal layer 23, the feed network 29 may directly transmit the radio frequency signal to the microstrip line 21, thereby reducing the loss of the radio frequency signal and improving the performance of the antenna, and the embodiments of the present disclosure do not make any specific limitations in this regard.

With continued reference to FIGS. 28 and 29, optionally, the antenna provided by the embodiments of the present disclosure further includes a radio frequency signal interface 41 and a bonding pad 42. One end of the radio frequency signal interface 41 is connected to the feed network 29 and is fixed by the bonding pad 42, and the other end of the radio frequency signal interface 41 is configured to connect an external circuit such as a high-frequency connector. The radio frequency signal interface 41 may be set according to the actual situation, and the setting shown in FIGS. 28 and 29 is only an optional setting.

With continued reference to FIGS. 28 and 29, optionally, the phase shifter further includes an adhesive frame 43. The adhesive frame 43 surrounds the liquid crystal layer 23 and may be used for supporting the first substrate 11 and the second substrate 12 to provide an accommodation space for the liquid crystal layer 23 and seal the liquid crystal layer 23.

It is to be understood that various forms of processes shown above may be adopted with steps reordered, added, or deleted. For example, the steps described in the present disclosure may be performed in parallel, sequentially, or in different sequences, as long as the desired results of the solutions of the present disclosure can be achieved, and no limitation is imposed herein.

The preceding embodiments are not construed as a limitation of the scope of the present disclosure. It is to be understood by those skilled in the art that various modifications, combinations, sub-combinations, and substitutions may be made according to design requirements and other factors. Any modifications, equivalent substitutions, improvements and the like made within the spirit and principle of the present disclosure are within the scope of the present disclosure.

What is claimed is:

1. A phase shifter, comprising:
a first substrate and a second substrate that are disposed opposite to each other; and
at least one phase shift unit, wherein a phase shift unit of the at least one phase shift unit comprises a microstrip line, an auxiliary electrode, a liquid crystal layer, and a grounding metal layer;
wherein the liquid crystal layer is located between the first substrate and the second substrate;
the microstrip line is located on a side of the second substrate facing the liquid crystal layer;
the grounding metal layer is located on a side of the first substrate facing the liquid crystal layer; and
at least one of the following configurations is satisfied: the auxiliary electrode is located between the first substrate and the liquid crystal layer or the auxiliary electrode is located between the second substrate and the liquid crystal layer.

2. The phase shifter according to claim 1, wherein
a working stage of the phase shifter sequentially comprises a first state stage, a state switching stage, and a second state stage;
in the first state stage, an included angle between a long axis of a liquid crystal molecule in the liquid crystal layer and a second direction is a first included angle;
in the second state stage, the included angle between the long axis of the liquid crystal molecule and the second direction is a second included angle;
wherein the first included angle is greater than the second included angle; and
the second direction is parallel to a plane on which the first substrate is located; and
in the state switching stage, the auxiliary electrode is configured to drive the liquid crystal molecule to be deflected in a first direction;
wherein the first direction is a direction in which the long axis of the liquid crystal molecule is deflected away from a direction perpendicular to the plane on which the first substrate is located.

3. The phase shifter according to claim 2, wherein
in the first state stage, the microstrip line is configured to receive a first drive voltage;
in the state switching stage, the microstrip line is configured to receive a second drive voltage, and the auxiliary electrode is configured to receive an auxiliary voltage to enable the auxiliary electrode to drive the liquid crystal molecule to be deflected in the first direction; and
in the second state stage, the microstrip line is configured to receive the second drive voltage;
wherein a voltage difference between the first drive voltage and a voltage on the grounding metal layer is a first voltage difference;
a voltage difference between the second drive voltage and the voltage on the grounding metal layer is a second voltage difference; and
the first voltage difference is greater than the second voltage difference.

4. The phase shifter according to claim 2, wherein
the larger a difference between the first included angle and the second included angle is, the longer a duration of the state switching stage is.

5. The phase shifter according to claim 2, wherein
the auxiliary electrode comprises a first electrode and a second electrode;
in the direction perpendicular to the plane on which the first substrate is located, the first electrode and the second electrode are located on a same side of the liquid crystal layer; and
when the auxiliary electrode drives the liquid crystal molecule to be deflected in the first direction, the first electrode is configured to receive a first auxiliary voltage, the second electrode is configured to receive a second auxiliary voltage, and the first auxiliary voltage is different from the second auxiliary voltage.

6. The phase shifter according to claim 5, wherein
the larger a difference between the first included angle and the second included angle is, the larger a voltage difference between the first auxiliary voltage and the second auxiliary voltage is.

7. The phase shifter according to claim 5, wherein
the first electrode and the second electrode are located on two sides of the microstrip line in a third direction, respectively; and
the third direction is parallel to the plane on which the first substrate is located and perpendicular to an extension direction of the microstrip line.

8. The phase shifter according to claim 7, wherein
a spacing between the first electrode and the second electrode in the third direction is L1, and L1 ≤6*L0;
wherein L0 is a line width of the microstrip line.

9. The phase shifter according to claim 7, wherein
a spacing between the first electrode and the microstrip line in the third direction is L2;
a spacing between the second electrode and the microstrip line in the third direction is L3; and
L2=L3.

10. The phase shifter according to claim 7, wherein
a spacing between the first electrode and the microstrip line in the third direction is L2;
a spacing between the second electrode and the microstrip line in the third direction is L3; and
L0≤L2≤3*L0, and L0≤L3≤3*L0;
wherein L0 is a line width of the microstrip line.

11. The phase shifter according to claim 7, wherein
the auxiliary electrode comprises a first auxiliary electrode and a second auxiliary electrode;
the first auxiliary electrode and the second auxiliary electrode are located on a same side of the liquid crystal layer, and the first auxiliary electrode is insulated from the second auxiliary electrode; and
in a direction parallel to the plane on which the first substrate is located, a distance between a first electrode of the first auxiliary electrode and a second electrode of the first auxiliary electrode is a first distance, and a distance between a first electrode of the second auxiliary electrode and a second electrode of the second auxiliary electrode is a second distance;
wherein the first distance is shorter than the second distance.

12. The phase shifter according to claim 11, wherein
when the auxiliary electrode drives the liquid crystal molecule to be deflected in the first direction, a voltage difference between a first auxiliary voltage received by the first auxiliary electrode and a second auxiliary voltage received by the first auxiliary electrode is less than a voltage difference between a first auxiliary voltage received by the second auxiliary electrode and a second auxiliary voltage received by the second auxiliary electrode.

13. The phase shifter according to claim 1, wherein
a resistance of the auxiliary electrode is larger than a resistance of the microstrip line.

14. The phase shifter according to claim 1, wherein at least one of the following configurations is satisfied:
the auxiliary electrode comprises a third auxiliary electrode located between the first substrate and the liquid crystal layer or the auxiliary electrode comprises a fourth auxiliary electrode located between the second substrate and the liquid crystal layer.

15. The phase shifter according to claim 14, wherein
the third auxiliary electrode is insulated from the grounding metal layer.

16. The phase shifter according to claim 15, wherein
the third auxiliary electrode is located on a side of the grounding metal layer facing the liquid crystal layer; and
a first insulating layer is disposed between the third auxiliary electrode and the grounding metal layer.

17. The phase shifter according to claim 14, wherein
the fourth auxiliary electrode and the microstrip line are located in a same layer.

18. The phase shifter according to claim 14, wherein
the fourth auxiliary electrode and the microstrip line are located in different layers.

19. The phase shifter according to claim 14, wherein
the auxiliary electrode comprises a first electrode and a second electrode;
in a direction perpendicular to a plane on which the first substrate is located, the first electrode and the second electrode are located on a same side of the liquid crystal layer;
the auxiliary electrode comprises a third auxiliary electrode and a fourth auxiliary electrode;
in the direction perpendicular to the plane on which the first substrate is located, a first electrode of the third auxiliary electrode at least partially overlaps a first electrode of the fourth auxiliary electrode; and
in the direction perpendicular to the plane on which the first substrate is located, a second electrode of the third auxiliary electrode at least partially overlaps a second electrode of the fourth auxiliary electrode.

20. An antenna, comprising a phase shifter and a radiation electrode, wherein the phase shifter comprises:
a first substrate and a second substrate that are disposed opposite to each other; and
at least one phase shift unit, wherein a phase shift unit of the at least one phase shift unit comprises a microstrip line, an auxiliary electrode, a liquid crystal layer, and a grounding metal layer;
wherein the liquid crystal layer is located between the first substrate and the second substrate;
the microstrip line is located on a side of the second substrate facing the liquid crystal layer;
the grounding metal layer is located on a side of the first substrate facing the liquid crystal layer; and
at least one of the following configurations is satisfied: the auxiliary electrode is located between the first substrate and the liquid crystal layer or the auxiliary electrode is located between the second substrate and the liquid crystal layer; and
wherein the radiation electrode is located on a side of the first substrate facing away from the grounding metal layer; and
the grounding metal layer comprises a first hollow portion, the radiation electrode covers the first hollow portion in a direction perpendicular to the first substrate.
